(19) United States
(12) Patent Application Publication
(10) Pub. No.: US 2009/0132437 A1
(43) Pub. Date: May 21, 2009

(54) METHODS, SYSTEMS, AND COMPUTER READABLE MEDIA CONTAINING INSTRUCTIONS FOR EVALUATING THE RETURN ON DIRECT MAIL MARKETING AND FOR EVALUATING SHIPPING SERVICES

(75) Inventors: Mike V. Naples, Keller, TX (US); Michael Douglas Clark, Fort Worth, TX (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: United States Postal Service, Washington, DC (US)

(21) Appl. No.: 12/210,706

(22) Filed: Sep. 15, 2008

Related U.S. Application Data
(62) Division of application No. 10/631,837, filed on Aug. 1, 2003.
(60) Provisional application No. 60/411,405, filed on Sep. 18, 2002.

(51) Int. Cl. G06Q 10/00; G06Q 50/00; G06Q 30/00

(52) U.S. Cl. 705/402; 705/401; 705/407; 705/411

(57) ABSTRACT

A method, system, and computer readable medium including instructions for evaluating and promoting a direct mail marketing campaign includes receiving the cost associated with the campaign and financial information for the campaign. The return on investment is calculated for the direct mail marketing campaign based on the cost and financial information. The return on investment is utilized to evaluate and promote the campaign.

### RELATED APPLICATIONS

This application is based upon and claims the benefit of priority from the prior U.S. Provisional Application No. 60/411,405 of Mike V. Naples and Mike D. Clark, filed Sep. 18, 2002, the contents of which are incorporated in their entirety herein by reference.

### FIELD

This invention relates to a system and method of evaluating business processes, and, more particularly, it relates to determining the rate of return on investment for a direct mail campaign.

### BACKGROUND

Direct mail marketing is a process by which a company or agency can advertise a product or service directly to potential customers. For example, a car dealership in Washington, D.C. is planning a Labor Day sale in order to reduce the inventory of cars. Since the car dealership sells sports cars, it desires to specifically advertise the sale to prospective male customers in the Washington, D.C. area under the age of 50. First, the car dealership hires an advertising agency to produce a sales flyer that can be sent to the prospective customers. The advertising agency designs the sales flyer and gives the prototype to the car dealership.

Next, the car dealership hires a data mining agency to produce of list of male customers in the Washington, D.C. area that are under the age of 50. This list includes, for example, the name, age, address, and telephone number of the customer demographic that the car dealership requested.

Then, the car dealership hires a printing company to mass produce enough sales flyers to be sent to prospective customers on the list. The printing company receives the sales flyer produced by the advertising agency and mass produces the sales flyer. The printing company can also fold and stuff the flyers in envelopes and address them. The car dealership can hire a separate mailing company to fold, stuff, and address the envelopes.

Finally, the car dealership hires a shipping company to ship the sales flyers to the prospective customers. The shipping company can be any appropriate delivery service provider, such as the United States Postal Service (“USPS”). The prospective customers then receive the sales flyers prior to the sale date and possibly attend the sales event based on the sales flyers.

A direct mail marketing campaign is not limited to sales flyers and letters for retail companies, but can also be used to disseminate catalogs, samples, and coupons to prospective customers. The direct mail marketing campaign can also be used to target existing customers as well as future customers. Furthermore, the companies utilizing direct mail marketing are not limited to retail companies selling products. Direct mail marketing can also be utilized by non-profit agencies, political campaigns, and lobby groups to distribute material regarding their causes to a population demographic.

The direct mail marketing campaign has the disadvantage that the company using the direct mail has no way to easily project the return on investment from the marketing campaign. In the car dealership example, the dealership has no easy way to determine how much profit will be made by shipping the flyers. Moreover, since the advertising, printing, and shipping companies seek direct mail marketing business, these companies also desire to demonstrate the advantages of a direct mail marketing campaign. However, these companies have no way to easily advertise the advantages of using a direct mail marketing campaign to prospective mailers.

### SUMMARY

Accordingly, the present invention is directed to a direct mail marketing evaluation process and system, a direct mail marketing promotion system, and a shipping service comparison system which substantially obviates one or more of the limitations and disadvantages of the related art.

In accordance with aspects consistent with the present invention, methods, systems, and computer readable media including instructions for evaluating a direct mail marketing campaign comprise: receiving a number of customers targeted for the direct mail marketing campaign; receiving a type of shipping service for the direct mail marketing campaign; receiving a production cost of the direct mail marketing campaign; receiving a cost of the shipping service; receiving financial information for the direct mail marketing campaign; determining the return on investment of the direct mail marketing campaign based on the production cost, shipping service cost, and financial information; and outputting the return on investment of the direct mail marketing campaign.

Other aspects consistent with the present invention directed to methods, systems, and computer readable media including instruction for promoting a direct mail marketing campaign comprise: receiving information on an entity for the direct mail marketing campaign; inputting the information; determining the return on investment of the direct mail marketing campaign based on the information; outputting and transmitting the return on investment to the entity, wherein the return on investment is used to promote a shipping service.

Other aspects consistent with the present invention directed to methods, systems, and computer readable media including instruction for comparing shipping services comprise: receiving at least shipping services to be compared; receiving at least one shipping method of each shipping service to be compared; receiving characteristics of items to be shipped by the at least one shipping method; receiving parameters of the at least one shipping method of each shipping service; determining the cost of the at least one shipping method; determining the difference in cost of the at least one shipping method of each shipping service; and outputting the difference in cost of the at least one shipping method of each shipping service.

It is to be understood that both the foregoing general description and the following detailed description are exemplary and explanatory only and are not restrictive of the invention, as claimed.

The accompanying drawings, which are incorporated in and constitute a part of this specification, illustrate several aspects consistent with the present invention and, together with the description, serve to explain these aspects of the invention.

### BRIEF DESCRIPTION OF THE DRAWINGS

FIG. 1 is a flowchart illustrating a direct mail marketing campaign evaluation process consistent with an aspect related to the present invention;

FIG. 2 is a diagram illustrating a system for performing several aspects consistent with the present invention;

FIG. 3 is a diagram of an introduction screen of an exemplary software module consistent with several aspects related to the present invention;

FIG. 4 is a diagram of a pre-production screen of an exemplary software module consistent with several aspects related to the present invention;

FIG. 5 is a diagram of a production screen of an exemplary software module consistent with several aspects related to the present invention;

FIG. 6 is a diagram of a ROM$ screen of an exemplary software module consistent with several aspects related to the present invention;

FIG. 7 is a diagram of a campaign manager screen of an exemplary software module consistent with several aspects related to the present invention;

FIG. 8 is a diagram of a chart screen of an exemplary software module consistent with several aspects related to the present invention;

FIG. 9 is a flowchart illustrating a direct mail marketing campaign evaluation scenario process consistent with an aspect related to the present invention;

FIGS. 10A and 10B are diagrams of scenario screens of an exemplary software module consistent with several aspects related to the present invention;

FIG. 11 is a flowchart illustrating a direct mail marketing campaign promotion process consistent with an aspect related to the present invention;

FIG. 12 is a diagram of a welcome screen of an exemplary software module consistent with several aspects related to the present invention;

FIG. 13 is a diagram of a next step screen of an exemplary software module consistent with several aspects related to the present invention;

FIG. 14 is a diagram of a trade show lead sheet screen of an exemplary software module consistent with several aspects related to the present invention;

FIG. 15 is a flowchart illustrating a shipping service comparison method consistent with an aspect related to the present invention;

FIG. 16 is a diagram of a mail piece screen of an exemplary software module consistent with several aspects related to the present invention;

FIG. 17 is a diagram of a package screen of an exemplary software module consistent with several aspects related to the present invention;

FIG. 18 is a diagram of a direct mail screen of an exemplary software module consistent with several aspects related to the present invention.

### DETAILED DESCRIPTION

Reference will now be made in detail to the aspects consistent with the present invention and exemplary embodiments of the invention, examples of which are illustrated in the accompanying drawings. Wherever possible, the same reference numbers will be used throughout the drawings to refer to the same or like parts.

One aspect consistent with the present invention is directed to a method of determining the return on a direct mail marketing campaign. This aspect allows a company to specify certain variables related to a marketing campaign and determine the return on investment based on these variables. These variables may include, for example, a target number of marketing prospects, production costs, type of shipping service, and expected response rate.

Another aspect consistent with the present invention is directed to a method of promoting the return on investment from a direct mail marketing campaign. This aspect allows companies to promote their direct mail marketing services to prospective companies by illustrating the advantages of a direct mail marketing campaign to the companies.

Another aspect consistent with the present invention is directed to a method for comparing the shipping method of shipping services. This aspect allows companies to determine the best and most cost efficient shipping methods available. Further, this aspect allows shipping services to promote the advantages of their shipping methods.

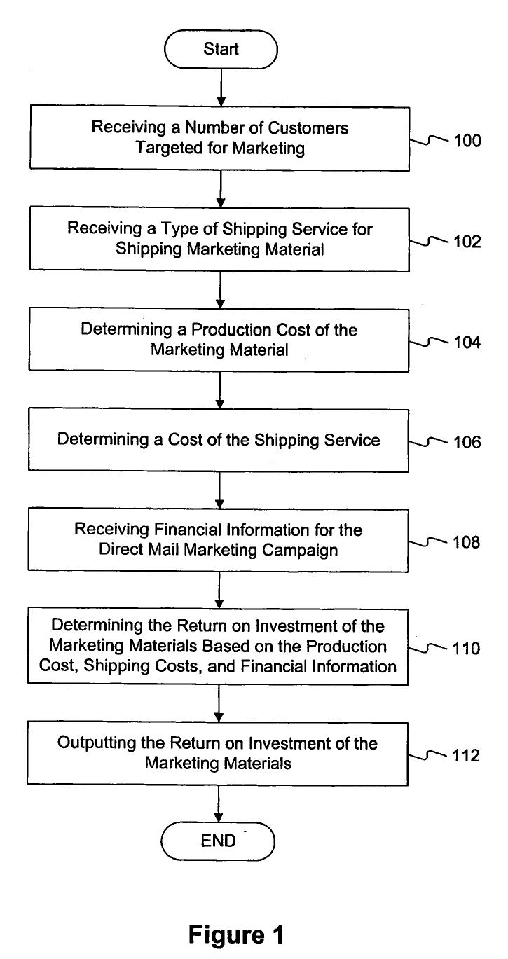

FIG. 1 illustrates a direct mail marketing campaign evaluation process consistent with one aspect of the present invention. This method may be performed by an operator utilizing a computer program. The process allows an operator to evaluate the direct marketing campaign based on the cost of the campaign and the expected results from the campaign.

In stage 100, the computer program receives a value representing the number of customers targeted for a direct marketing The operator supplies the number of targeted customers to the computer program. The number of targeted customers represents the number of pieces of marketing material that will be produced and shipped.

Next, in stage 102, the computer program receives a type of shipping service for shipping the marketing materials to the targeted customers. The operator specifies the type of shipping service to the computer program.

Then, in stage 104, the computer program determines a production cost for producing the marketing material. The operator supplies the itemized specifications for producing the marketing materials and the computer program determines the cost based on the specifications. The itemized costs can be, for example, printing costs, list acquisition costs, and creation costs for the marketing materials. Alternatively, the operator can supply an all-inclusive cost which represents the total production costs of the marketing material.

Next, in stage 106, the computer program determines the cost of the shipping service. In this stage, the operator can provide the cost of the shipping service including shipping rates and discounts. Alternatively, the operator can select from shipping rates and discounts stored by the computer program. Utilizing the rates, discounts, and number of targeted customers received in stage 100, the computer program determines the shipping cost of each marketing material and the shipping cost for all the marketing material.

Then, in stage 108, the computer program receives financial information for the direct marketing campaign. The financial information includes parameters for the effectiveness of the marketing material and expected profit of items marketed in the marketing campaign. In this stage, the operator supplies to the computer program the expected response rate of the marketing campaign and the expected profit from each sale. Using this information and the number of targeted customers supplied in stage 100, the computer program determines the number of responses to the marketing campaign and the expected profit for the entire marketing campaign.

Subsequently, in stage 110, the computer program determines the return on investment for the marketing material. In this stage, the computer program, utilizing the expected profit determined in stage 108, the shipping cost from stage 106, and the production cost from stage 104, determines the return on investment. The return on investment represents percentage of profits to the costs.

Finally, in stage 112, the computer program outputs the return on investment for the marketing materials. The computer program can output the return on investment in the form of reports or graphs.

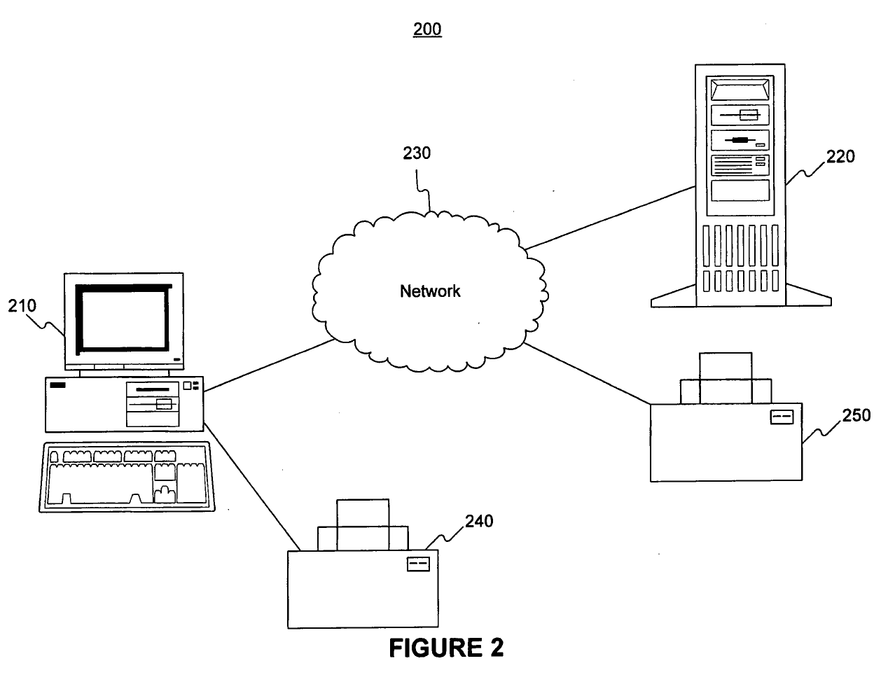

A system on which the above method may be performed will now be described with reference to FIG. 2. An evaluation system 200 consists of a computer system 210. Computer system 210 comprises a monitor, keyboard, and computer unit. The computer unit contains the standard components required for inputting, outputting, manipulating, and storing data. For example, the computer unit may be comprised of a central processing unit (CPU), random access memory (RAM), video card, sound card, magnetic storage devices, optical storage devices, input/output (I/O) terminals, and a network interface card (NIC). Computer system 210 can optionally be connected to a printer 240 through the I/O terminals. Examples of the I/O terminals to which the printer can be connected are parallel, serial, universal serial bus, and IEEE 1394. Also, if computer system 210 contains an NIC card, the system can be optionally connected to remote computing devices through a network 230. For example, network 230 can be a local area network (LAN), wide area network (WAN), or wireless network. Examples of remote computing devices to which computer system 210 may be connected are a remote server 220 and a remote printer 250.

The evaluation process as illustrated in FIG. 1 may be performed on evaluation system 200. The different stages of the method of FIG. 1 may be performed by, for example, a computer program or a financial spreadsheet. A computer program consistent with the present invention may be created using various programming languages or software suites. For example, the computer program can be a stand alone program coded in a language such as Java™ or C++, or it may be designed using a known spreadsheet program.

In an embodiment of the present invention, the evaluation process may be performed entirely by, for example, computer system 210. The computer program or spreadsheet for executing the stages of the evaluation process is stored at computer system 210. The program can be stored, for example, on one of the magnetic storage devices or optical storage devices contained in computer system 210. For example, magnetic storage devices, such as hard disk drives or floppy disk drives could be used to store the computer program or spreadsheet. Also, optical storage devices, such as CD-ROM, DVD, CD-R, or CD-RW could be used to store the computer program or spreadsheet. When the evaluation is ready to proceed, the computer program or spreadsheet is executed. Various parameters are inputted into the computer program or spreadsheet by an operator using the keyboard. The program may also be linked to databases located at computer system 210. The computer program or spreadsheet can query the database for values inputted into the different stages of the multistage evaluation system.

Once all of the parameters are entered, the computer program or spreadsheet performs the evaluation process. The results of the process can be displayed on the monitor of computer system 210. The results can be displayed in either numerical or graphical form. The operator can print the numerical or graphical results on printer 240.

After the initial evaluation process is complete, the computer program or spreadsheet may also perform a comparison analysis. The operator can change various parameters entered into evaluation system 200 to determine what effect the change has on the results. The results of the comparison analysis can be displayed on the monitor of computer system 210 in numerical or graphical form. Also, the operator has the option of printing a hard copy of the results of the comparison analysis on printer 240.

This method has so far been described as running locally on computer system 210. In another embodiment, a remote computer system may be used in combination with computer system 210. In this embodiment, the computer program or spreadsheet is functionally the same, but the location of the program, spreadsheet, or inputted data may differ. For example, instead of the computer program or spreadsheet being stored at computer system 210, the program or spreadsheet can be stored at remote server 220. In this embodiment, the computer program or spreadsheet would be stored on magnetic or optical storage devices located at remote server 220. Once the evaluation is ready to be performed, the computer program or spreadsheet would be transferred from remote server 220 across network 230 to computer system 210 for execution. Alternately, the computer program or spreadsheet can be remotely executed at remote server 220. Also, databases containing values inputted into the evaluation system can be stored at remote server 220. Once the evaluation process is performed, the results can be transferred across network 230 for display at remote server 220 or printing on remote printer 250.

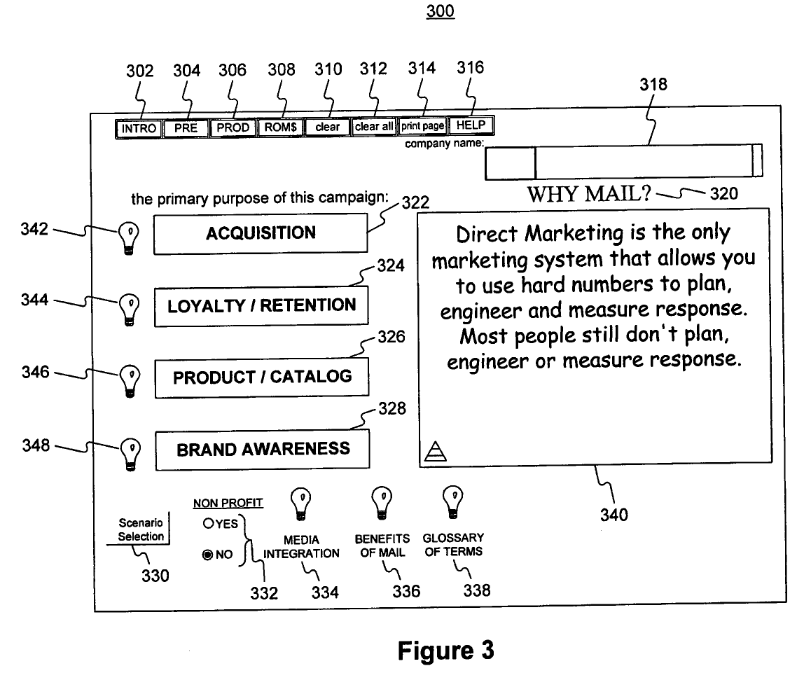

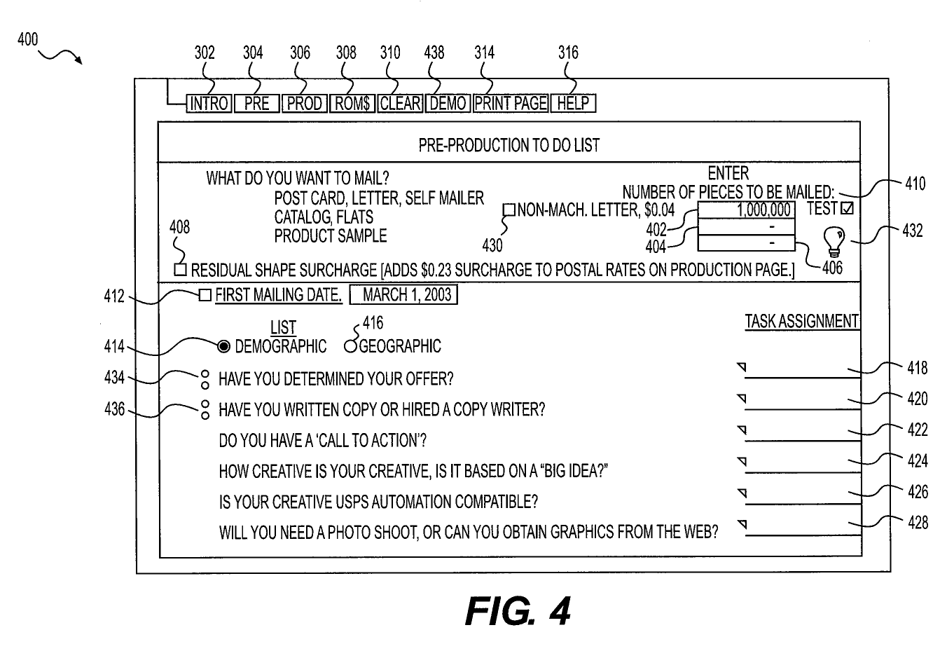

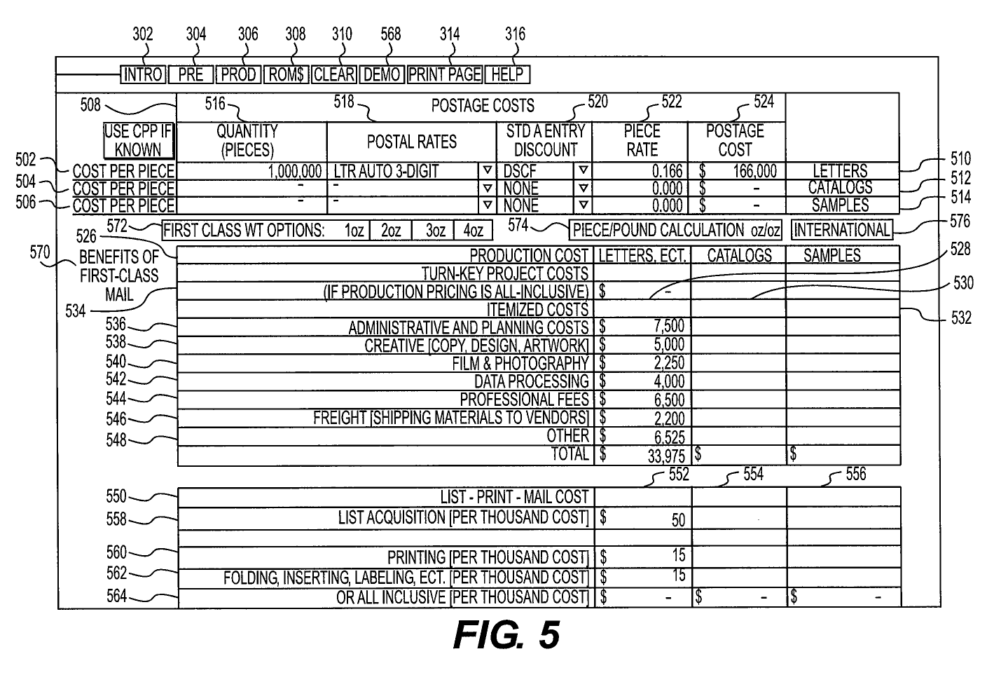

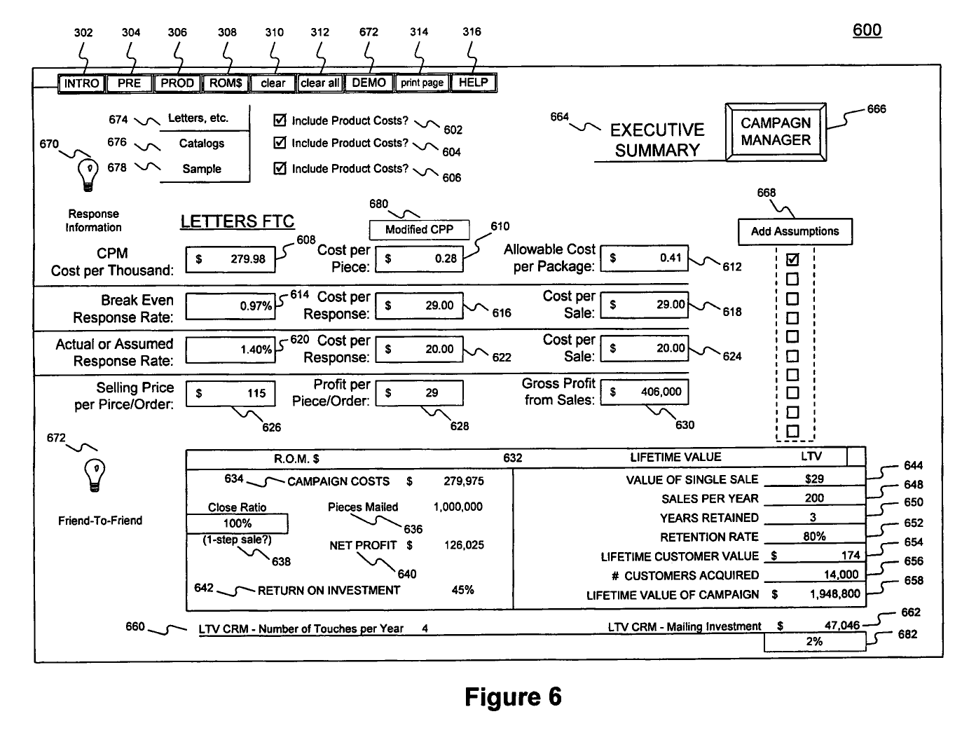

An exemplary software module for performing the process illustrated in FIG. 1 will now be explained with reference to FIGS. 3-8. The software module can be configured to function on the system illustrated in FIG. 2. FIGS. 3-8 are screen shots from the exemplary software module for performing the method illustrated in FIG. 1. FIG. 3 illustrates the first screen or introduction screen 300 that is displayed once the operator executes the direct mail marketing evaluation software module. Introduction screen 300 allows the operator to enter the initial parameters into the software module and provides information about the module. At the top of introduction screen 300 are selectable components 302-308 which allow the operator to navigate to the different screens of the software module. Selectable component 302 allows the operator to navigate to introduction screen 300. Selectable component 304 allows the operator to navigate to a pre-production screen 400 (explained below with reference to FIG. 4). Selectable component 306 allows the operator to navigate to a production screen 500 (explained below with reference to FIG. 5). Selectable component 308 allows the operator to navigate to a ROM$ screen 600 (explained below with reference to FIG. 6).

Also located at the top of introduction screen are selectable components 310-316. Selectable component 310 allows the operator to clear all operator supplied information from the introduction screen. Selectable component 312 allows the operator to clear all operator supplied information from all the screens including pre-production screen 400, production screen 500, and ROM$ screen 600. Selectable component 314 allows the operator to print a screen shot of introduction screen 300. For example, the screen shot can be printed on any or all of printers 240 and 250 illustrated in FIG. 2. Selectable component 316 allows the operator to retrieve help information about the software module.

The operator begins using the software module by first entering the company name in field 318. Next, the operator may toggle selectable component 320 to display a message in field 340. The message displayed in field 340 describes the advantages of direct mail marketing. Then, the operator defines the primary purpose of the direct mail marketing campaign by toggling one of objective selectable components 322, 324, 326, and 328. Once the operator toggles one of selectable components 322, 324, 326, and 328, a new message in displayed in field 340 describing the general purpose of each objective. Additionally, the operator can toggle selectable components 342, 344, 346, and 348 to access specific information describing how direct marketing may achieve each purpose.

Next, the operator defines whether the company using the software module is non-profit by toggling “YES” or “NO” in selectable component 332. If the operator toggles “YES,” the software module will activate the Non-Profit rate tables for all of the calculations for the remainder of the screens (explained below with reference to FIGS. 4-6). If the operator toggles “NO,” the software module will active the Regular Standard Shipping rates for all the calculations.

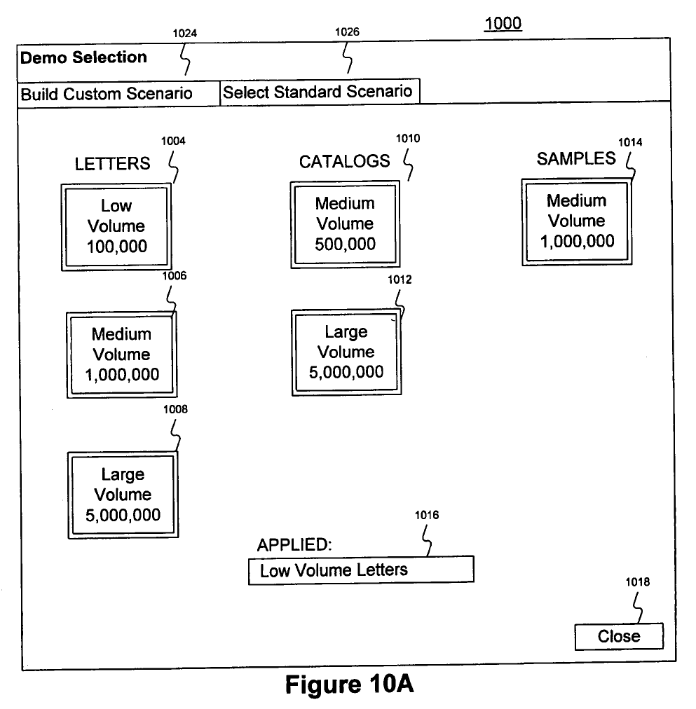

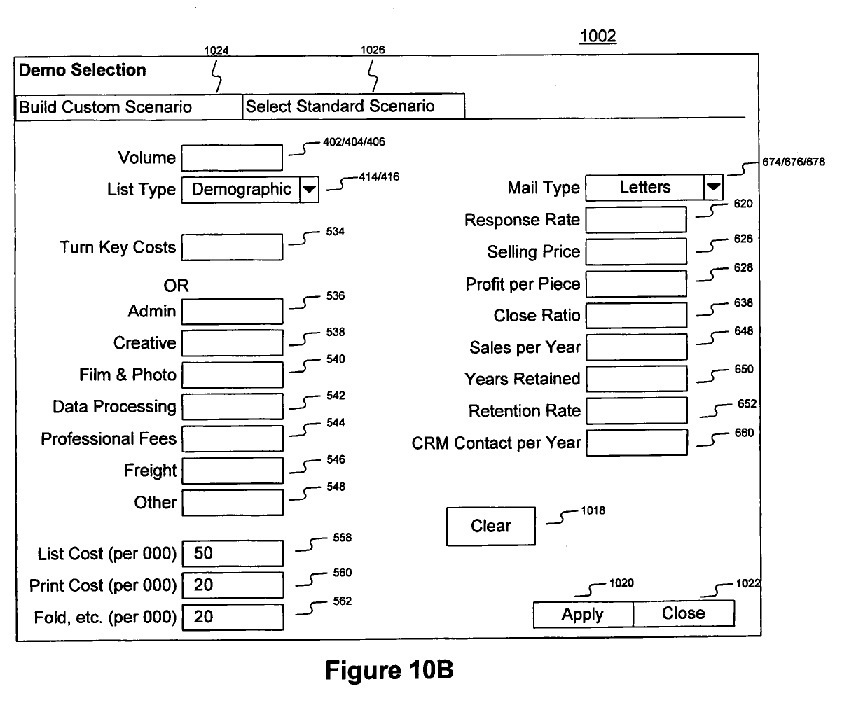

Introduction screen 300 also includes selectable components 334, 336, and 338. By selecting these components, the operator can access information regarding the advantages and features (334 and 336) of the software module, as well as a glossary of terms (338). Introduction screen 300 also includes selectable component 330 which allows the operator to execute a scenario for the software module (explained below with reference to FIGS. 10A and 10B).

Once the operator has entered all the appropriate parameters on introduction screen 300, the operator now proceeds to pre-production screen 400 by toggling selectable component 304.

The operation of pre-production screen 400 will now be explained with reference to FIG. 4. Pre-production screen 400 allows the operator to enter pre-production data which will be used by the software module. This data includes the number of marketing pieces to be mailed, pre-production costs associated with the marketing pieces, and the expected mailing date of the mail pieces. Pre-production screen 400 also includes a series of questions that help the operator plan for the direct mail marketing campaign.

As with introduction screen 300, pre-production screen 400 includes selectable components 302, 304, 306, 308, 310, 314, and 316, which allow the operator to navigate between the different screens, clear data from the screen, print the screen, and access help information. Also, pre-production screen 400 includes selectable component 438 that is used if a scenario has been selected on the introduction screen 300 (described below with reference to FIGS. 10A and 10B).

First, the operator enters the number of targeted customers which represents the number of pieces to be mailed into fields 402, 404, and 406. The operator enters the number of post cards, letters, and self mailers into field 402. The operator enters the number of catalogs and flats into field 404. The operator enters the number of product samples into field 406. Also, if the letters are non-machine readable, the operator can toggle selectable component 430 to add a surcharge to the shipping cost. Additionally, if samples are mailed and the mailed sample is over ¾″ thick, the operator can toggle selectable component 408 to add a residual shape surcharge to the shipping costs.

Next, the operator can toggle selectable component 410. Selectable component 410 allows the operator to specify that the direct mailing marketing campaign is a test. The operator can also toggle selectable component 432 to access background information on testing direct mail marketing. Then, the operator can toggle selectable component 412 in order to set the desired in-home date. Selectable component 412 will set this date to be 90 days from the date the software module is executed if a value is not specified by the operator.

Then, the operator specifies the type of list costs by toggling either selectable component 414 or 416. If selectable component 414 labeled “demographic” is toggled, the software module will automatically populate production screen 500 with list costs of $50 per thousand names. This cost represents the industry average cost of production for a mailing list based on demographic sampling. For example, a mailing list based on demographic information could only include married couples over the age of 30. This cost can be changed as needed in production screen 500. If selectable component 416 labeled “geographic” is toggled, the software module will populate production screen 500 with list costs of $20 per thousand. This cost represents the industry average cost of producing a mailing list based on geographic information. For example, a mailing list based on geographic information could only include residents from a particular town. This cost can be changed as needed in production screen 500. In this example, the demographic selectable component 414 has been toggled.

The final selectable components 418, 420, 422, 424, 426, and 428 of pre-production screen 400 educate the operator on the steps necessary in planning a direct mail marketing campaign and help the operator plan these steps. This includes a series of questions which the operator answers by toggling selectable components 418, 420, 422, 424, 426, and 428. For example, the question may include, “Have you determined your offer?” The operator may also toggle selectable components 434 and 436 to access detailed information on each question asked.

Once the operator has entered the necessary information, the operator proceeds to production screen 500 by toggling selectable component 306.

The operation of production screen 500 will now be explained with reference to FIG. 5. Production screen 500 allows the operator to enter production data which will be used by the software module. This data includes shipping costs, production costs, and list print costs.

As with pre-production screen 400, production screen 500 includes selectable components 302, 304, 306, 308, 310, 314, and 316, which allow the operator to navigate between the different screens, clear data from the screen, print the screen, and access help information. Also, production screen 500 includes selectable component 568 that is used if a scenario has been selected on introduction screen 300 (described below with reference to FIG. 10).

Production screen 500 allows the operator to enter the total cost of each piece of marketing material to be mailed. Alternatively, the operator can enter the specific shipping, production, and list print costs. If the operator knows the total cost per piece, the operator may enter this total cost by toggling selectable component 502 to enter the costs per piece for each letter, by toggling selectable component 504 to enter the cost per piece for each catalog, and by toggling selectable component 506 to enter the cost per piece for each sample.

If the operator does not know the cost per piece for each item, the operator can enter the various costs into tables 508, 526, and 550, and the software module will determine the cost per piece. First, the operator enters the cost associated with shipping into shipping costs table 508. Table 508 includes three rows, 510, 512, and 514, for entering data about letters, catalogs, and samples, respectively. Table 508 also includes columns 516, 518, 520, 522, and 524 for entering values for quantity, postal rates, discounts, piece rates, and postage costs.

Column 516 displays the quantity (number of pieces) that will be shipped in the direct mail marketing campaign. The software module automatically populates column 516 with the number of pieces to be shipped entered by the operator in fields 402, 404, and 406 of pre-production screen 400. In this example, the software module populates column 516, row 510 with a quantity of 1,000,000 letters.

Next, the operator specifies the shipping rate of each type of marketing mail piece in column 518. Each row in column 518 is a selectable component that allows the operator to select from various standard shipping rates. For example, the selectable components in column 518 may include standard USPS shipping rates for each type of marketing mail piece, such as letter auto 3-digit and letter auto mixed. The different shipping rates are obtained from the shipping service and are stored in the software module. In this example, the operator selects letter auto 3-digit as the shipping method.

Then, the operator specifies any discounts available for the type of shipping rate selected in column 520. Each row in column 520 is a selectable component that allows the operator to select from various standard shipping rate discounts. For example, if the direct mail marketing material is being shipped in a certain geographic area, certain discounts may apply for certain shipping rates. These discounts are available from the shipping service and stored in the software module. In this example, the operator selects an entry discount DSCF for the letter auto 3-digit.

Production screen 500 also includes selectable component 572. If a First-Class Mail rate is selected, different weight options can be chosen with selectable component 572. Changing the weight class will effect the shipping rate. Additionally, selectable component 570 allows the operator to access information on the benefits of First-Class Mail.

Production screen 500 also includes selectable component 574. If a catalog or sample weighs more than 3.3 ounces, selectable component 574 will allow the operator to select the appropriate rate category and weight in ounces.

Production screen 500 also includes selectable component 576. If an international product is to be proposed, selectable component 576 will allow the operator to select the appropriate rate, using the proper country group, weight in ounces, and presort level. As with domestic rates, the different international shipping rates are obtained from the international shipping service and are stored in the software module.

Once the operator has selected the shipping rate and any discount, the software module calculates the shipping rate per piece. The software module determines the piece rate by determining the shipping rate selected by the operator and displays this amount in column 522. In this example, since the operator selected letter auto 3-digit, the software module accesses as the stored shipping rates and displays a rate of $0.166 in column 522, row 510.

Then, the software module determines the total shipping cost by multiplying the shipping rate per piece displayed in column 522 by the quantity of pieces displayed in column 516 and subtracting any discounts displayed in column 520. The software module displays the results in column 524. In this example, the shipping costs for the 1,000,000 letters is $166,000.

Next, the operator enters data regarding the production cost of the direct mailing marketing material in production cost table 526. Table 526 includes columns 528, 530, and 532 for entering the production costs for letters, catalogs, and samples, respectively. If the operator knows the turn-key cost for producing the marketing material (i.e., all-inclusive price), the operator can enter the turn-key cost in row 534. If the operator does not know the turn-key cost, the operator can enter the itemized cost for producing the marketing material in rows 536, 538, 540, 542, 544, 546, and 548. These costs include administrative and planning costs (row 536), creative costs (row 538), film and photography (row 540), data processing (row 542), professional fees (row 544), freight (row 546), and other costs (row 548).

Administrative and planning costs could include the man-hour costs associated with a project development team, travel, consultant fees, or any related campaign-planning expenses. Creative costs could include billable expenses for concept and design work. Film and photography costs could include the cost of internal or external billable expenses required for a photo shoot for the creative or catalog pages and could include equipment, travel, studio hours, model fees, rights to photos, etc. Data processing could include the cost of data mining techniques, such as recency, frequency, monetary (RFM), or transactional data issues. Data processing could also include the cost of systems, such as deduping, National Change of Address (NCOA), Coding Accuracy Support System (CASS) or postal sortation and any other fees associated with the processing of the list. Professional fees could include costs associated with legal consultation for copy review or state regulations of the offer, or agency consultation fees. Freight could include the costs to move materials from the printer to the mailing house, and shipping to destination entry points.

In this example, the operator enters the following itemized production costs: administrative—$7,500; creative—$5,000; film and photography—$2,250; data processing—$4,000; professional fees—$6,500; freight—$2,200; and other—$6,525. The software module will add these costs to the shipping cost to determine a total cost.

Finally, the operator enters data associated with producing the list of potential target marketing customers in list print table 550. Table 550 includes columns 552, 554, and 556 for entering the print mail costs for letters, catalogs, and samples, respectively. First, the software module populates list acquisition cost row 558 based on the operator selection in fields 414 and 416 of pre-production screen 400. Alternatively, the operator can enter a different value in row 558. In this example, since the operator selected field 414 for demographic, the software module populates column 552, row 558 with a list acquisition cost of $50.

Then, the operator enters the printing costs. If the operator knows the all-inclusive cost for producing and printing the marketing material, the operator can enter the all-inclusive cost in row 564. If the operator does not know the all-inclusive cost, the operator can enter the itemized cost per thousand for producing the marketing material in rows 560 and 562. The cost are printing costs (row 560) which include costs associated with printing of the actual marketing material, and folding, inserting, and labeling costs (row 562), which include costs associated with additional preparation of the marketing material, such as inserting, stitching, stapling, lasering, and sample overwrap. In this example, the operator entered a printing cost of $15 per thousand and a folding, inserting, and labeling cost of $15 per thousand. The software module will add these costs to the shipping and productions costs to determine a total cost.

After the operator has entered all the production information, the user toggles selectable component 308 to proceed to ROM$ screen 600. The operation of ROM$ screen 600 will now be explained with reference to FIG. 6. ROM$ screen 600 allows the operator to enter data regarding the response rate from the marketing material. This data includes response rate and the profit per order. ROM$ screen 600 displays the financial information regarding the marketing campaign. This information includes the return on investment.

As with production screen 500, ROM$ screen 600 includes selectable components 302, 304, 306, 308, 310, 312, 314, and 316, which allow the operator to navigate between the different screens, clear data from the screen, print the screen, and access help information. Also, ROM$ screen 600 includes selectable component 672 that is used if a scenario has been selected on introduction screen 300 (described below with reference to FIGS. 10A and 10B).

First, the operator selects the type of marketing material that will be mailed by toggling either selectable components 674, 676, or 678. The user may calculate the return on investment for one type of marketing material, but the user may execute ROM$ screen 600 multiple times for the different marketing material. Then, the operator specifies if the production data entered in production screen 500 will be used in calculating the return on investment for the marketing material selected. The operator specifies this by toggling selectable components 602, 604, and 606. In this example, the operator toggled selectable components 674 and 602 to calculate the return on investment including the production costs.

Based on the user selection of marketing material, the software module calculates the cost per thousand and displays this value in field 608. The software module determines the cost per thousand by taking the total cost and dividing the total cost by the number of thousands of marketing materials mailed entered in field 402. The software module calculates the total cost by summing the cost entered in pre-production screen 400 and production screen 500 minus any discounts entered on these pages. In this case, the cost per thousand is $279.98.

Then, the software module determines the cost per piece by dividing the cost per thousand by 1,000 and displays this value in field 610. In this case, the cost per piece is $0.28. The operator may also enter a cost per piece by toggling selectable component 680 and entering the cost per thousand in field 610.

Next, the operator enters data regarding the effectiveness of the marketing campaign. First, the operator enters actual or assumed response rate in field 620. The actual or assumed response rate is the rate of response that is expected for the marketing materials, based on factors including offer, list targeting, and creativity. In this example, the actual or assumed response rate is 1.40%.

Next, the operator enters the selling price per piece in field 626. The selling price per piece is the retail price that is paid for the item or items which are the focus of the marketing campaign in an average sale. In this example, the selling price per piece is $115.00.

Then, the operator enters the profit per piece/order in field 628. The profit per piece/order is what the company defines as the profit that they make on each sale. In this example, the profit per piece/order is $29.00.

After the operator has entered all the data on the effectiveness of the marketing campaign, the software module will calculate the various costs and profit and the return on investment. First, the software module calculates the allowable cost per package and displays this value in field 612. The allowable cost per package is the most the company can afford to spend based on calculations using the actual or assumed response rate. The allowable cost per package is calculated by multiplying the actual or assumed response rate by the profit per piece/order. In this case, the allowable cost per piece is $0.41.

Then, the software module calculates the break even response rate and displays this value in field 614. The break even response rate is calculated based on the production costs and the profit made per sale. The software module calculates the break even response rate by dividing the cost per piece by the profit per piece/order. Any less response than this and the campaign loses money; any more, a profit can be expected. In this example, the break even response rate is 0.97%.

Next, the software module calculates the cost per response and the cost per sale for the break even response rate and displays the values in fields 616 and 618, respectively. The software module calculates the cost per response by dividing the cost per piece by the break even response rate. The cost per sale is the same as the cost per response unless sales are made to less than 100% of respondents or the sale is a two or more step process. If so, the operator can enter a different value in field 618. In this example, the cost per response and the cost per sale is $29.00.

Then, the software module calculates the cost per response and the cost per sale for actual or assumed response rate and displays the values in fields 622 and 624, respectively. The software module calculates the cost per response by dividing the cost per piece by the actual or assumed response rate. The cost per sale is the same as the cost per response unless sales are made to less than 100% of respondents or the sale is a two or more step process. If so, the operator can enter a different value in field 624. In this example, the cost per response and the cost per sale is $20.00.

Next, the software module calculates the gross profit from sales and displays this value in field 630. The gross profit from sales is the profit made from the total sales expected during the campaign. This amount is the gross amount before deducting the costs of the marketing campaign. The software module calculates the gross profit by multiplying the profit per piece/order, the actual or assumed response rate, and the number of marketing materials mailed. In this example, the gross profit is $406,000.

Now, the software module calculates the return on marketing investment and the lifetime value of the marketing campaign and displays the results in table 632. First, the software module calculates the cost of the campaign and displays the value in field 634. The software module calculates the cost of the campaign by multiplying the cost per piece and the number of marketing materials mailed. The software module displays the number of marketing materials mailed in field 636. The value is taken from field 402 of pre-production screen 400. In this example, the campaign costs are $279,975.

Next, the operator can enter a close ratio in field 638. If a response equals a sale, the close ratio is 100%, which is the default value. This value affects the cost per sale explained earlier. The operator may enter a lower close rate if known. Then, the software module calculates a net profit and displays the value in field 640. The net profit is the profit after deducting the production and mailing costs of the campaign. The software module calculates the net profit by subtracting the cost of the campaign from the gross profit from sales. In this example, the net profit is $126,025.

Now, the software module calculates the return of investment and displays this value in field 642. The return on investment is the percentage of the net profit to the campaign costs. The software module calculates the return on investment by dividing the net profit by the cost of the campaign and multiplying the result by 100% to obtain a percentage. In this example, the return on investment is 45%.

Next, the software module calculates the lifetime value of the marketing campaign. First, the software module populates field 644 with the profit per piece in order to represent the value of a single sale. The operator can enter a different value if necessary. Then, the operator enters the number of expected sales per year in field 648, the number of years a customer is retained in field 650, and the retention rate of each customer in field 652. The retention rate is the percentage of customers expected to be retained over the years. In this example, the sale per year, the number of years a customer is retained, and the retention rate are 200, 3, and 80%, respectively.

Then, the software module calculates the lifetime value of each customer and displays this value in field 654. The lifetime value is the value of a single customer who makes the expected number of purchases over the expected number of years in their lifetime. The software module calculates the lifetime value by multiplying the value of a single sale, the sales per year, and the years retained. In this example, the lifetime value is $174.00.

Next, the software module calculates the number of customers acquired and displays this value in field 656. The number of customers acquired is the number of customers that will place orders from this marketing campaign. The software module calculates this value by multiplying the number of marketing materials by the actual or assumed response rate. In this case, the number of customers acquired is 14,000.

Finally, the software module calculates the lifetime value of the marketing campaign and displays this value in field 658. The lifetime value is based on the number of new customers obtained from the campaign and their expected purchases over their lifetime as a customer. The software module calculates this value by multiplying the lifetime customer value, the number of customers acquired, and the retention rate. In this example, the lifetime value is $1,948,800.

Additionally, the operator can determine the life time value customer relationship management mailing investment. This value is how much may be spent in mailings to maintain contact with the customer. First, the operator enters the number of touches per year in field 660. The number of touches per year is the number of times that contact with the customer via mail is expected in a year's time. Then, the software module calculates the mailing investment and displays this value in field 662. The software module calculates this value by multiplying the number of customers acquired, the cost per piece, the number of years retained, and the number of touches per year. In this example, the mailing investment is $47,046. The software module also displays this value as a percentage of the lifetime value of the campaign in field 682.

The operator can also access general information of response information and friend-to-friend transactions by toggling selectable components 670 and 672.

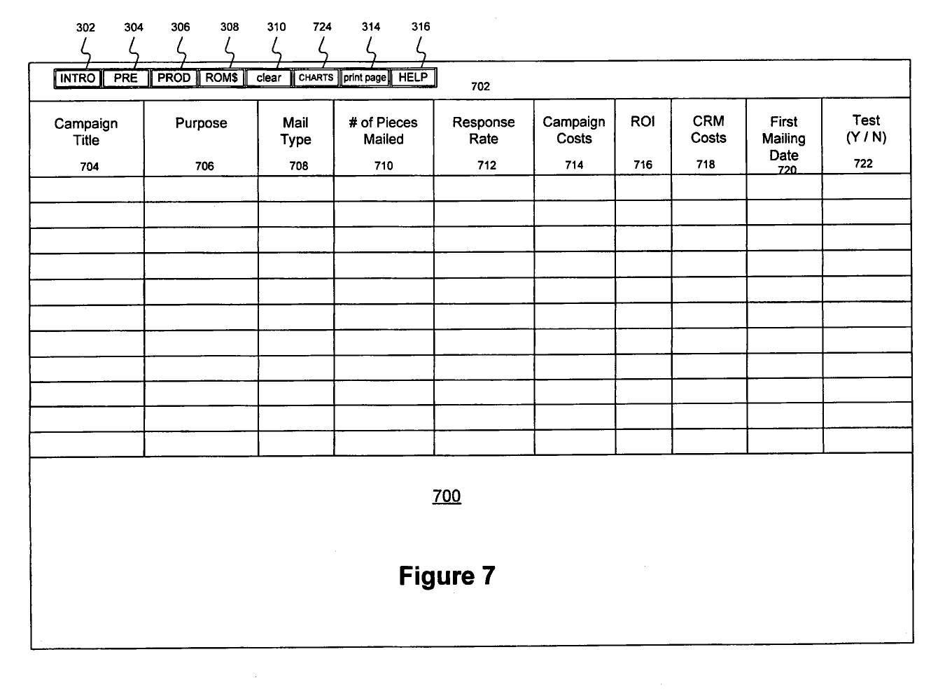

Now that all the values have been entered, the operator can print out the relevant information and save the data entered. The operator can display and print out an executive summary by toggling selective component 664. The executive summary includes all the data displayed in table 632. Further, the operator can customize the executive summary to include any of the data from ROM$ screen 600. Next, the operator can save the information by toggling selectable component 666. Selectable component 666 directs the operator to the campaign manager screen 700. Campaign manager screen 700 will now be described with reference to FIG. 7.

As with ROM$ screen 600, campaign manager screen 700 includes selectable components 302, 304, 306, 308, 310, 314, and 316, which allow the operator to navigate between the different screens, clear data from the screen, print the screen, and access help information.

Campaign manger screen 700 comprises table 702 in which the data from each marketing campaign simulated in stored. For each time a marketing campaign is tested, the software module generates an entry in a row of the table. The operator initiates the entry of data by toggling one of the components of selectable multi-component 668 in ROM$ screen 600. Each time the operator enters data for a marketing campaign and toggles one of the components of 668, the data for that marketing campaign is entered into a row of table 702.

The operator can enter a campaign title in column 704 for each run of the software module and the software module populates the remaining columns. The software module first populates column 706 with the purpose of the campaign. The purpose of the campaign was specified by the operator by toggling one of the selectable components 322, 324, 326, or 328 in introduction screen 300. Next, the software module populates column 708 with the marketing material type. The marketing material type was specified by the operator by toggling one of the selectable components 674, 676, or 678 in ROM$ screen 600.

Then, the software module populates column 710 with the number of targeted customers. The number of targeted customers was specified by the operator in field 402 of introduction screen 400.

Next, the software module populates column 712 with the response rate. The operator specified this value in field 620 in ROM$ screen 600. Next, the software module populates column 714 with the campaign costs. The software module determined this value and displayed it in field 634 of ROM$ screen 600. Now, the software module populates column 716 with the return on investment. The software module determined this value and displayed it in field 642 of ROM$ screen 600. Next, the software module populates column 718 with the CRM costs. The software module determined this value and displayed it in field 662 of ROM$ screen 600.

Finally, the software module populates columns 720 and 722 with the first mailing date and test status. The operator specified these values in field 412 and selectable component 410, respectively.

Once the data has been entered into table 702, the operator can direct the software module to generate charts by toggling selectable component 724. The software module will generate a separate chart for each row of table 702.

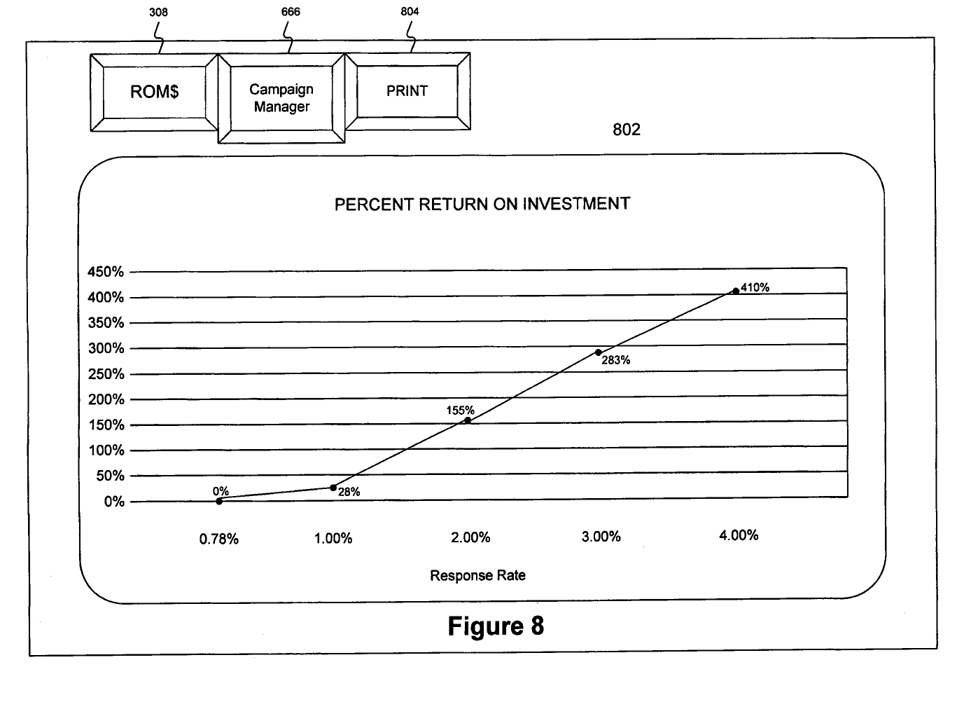

FIG. 8 is an example chart screen 800. Chart screen 800 includes a chart 802 produced when the operator toggles selectable component 724 of campaign manager screen 700. The chart displays the return on investment for different response rates. The software module determines the return on investment by the same calculation performed in ROM$ screen 600 and using the data of the marketing campaign. The software module generates different returns on investments for different response rates and plots the results.

Chart screen 800 also includes selectable components 308 and 666 that allow the operator to return to previous screens. Also, chart screen 800 includes selectable component 804 that allows the operator to print chart 802.

In the above embodiment of the invention, the operator supplies most of the data to the software module used in determining the return on direct mail marketing. The software module allows the operator to enter the data and determine a return on investment and then, enter new data to determine a new return on investment. This allows the operator the ability to determine what effects certain costs and assumptions, such as response rate, will have on the return on investment. Thus, the operator can compare different marketing campaigns and determine the best option for the company.

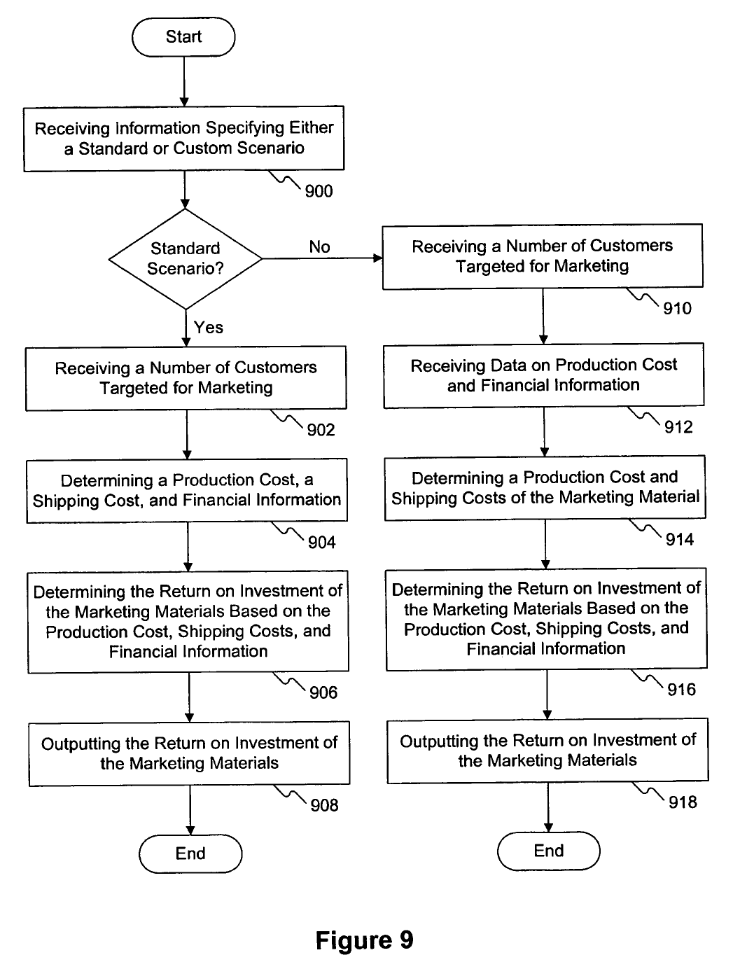

In another aspect of the present invention, the operator can run a scenario on the computer program. FIG. 9 is a flow chart illustrating a return on direct marketing process on a computer program and system in which the operator utilizes a scenario. The process closely follows the process illustrated in FIG. 1. The difference is the operator supplies less information to the computer regarding cost and effectiveness, but the computer program generates the information based on preprogrammed data.

Finally, in stage 908, the computer program outputs the return on investment for the marketing materials. The computer program can output the return on investment in the form of reports or graphs.

If the operator selected custom scenario, in stage 910, the computer program receives a number of customers targeted for a direct mail marketing campaign. The operator supplies the number of targeted customers to the computer program by selecting from a set of preprogrammed numbers of targeted customers. The number of targeted customers represents the number of pieces of marketing materials that will be produced and shipped.

Next, in stage 912, the computer program receives the production cost of the marketing material. The operator supplies the itemized specifications for producing the marketing materials and the computer program determines the cost based on the specifications. The itemized cost can be, for example, printing cost, list costs, and creation costs for the marketing materials. Alternatively, the operator can supply an all-inclusive cost which represents the total production costs of the marketing material. Also, in stage 912, the computer receives financial information, such as expected response rate of the target customers and an expected profit.

Then, in stage 914, the computer program determines a production cost for producing the marketing material. The computer program determines the production cost based on the data supplied by the operator in stage 912.

Also, in stage 914, the computer program determines the cost of the shipping service. The computer program is preprogrammed with scenario data for determining the shipping cost based on the number of targeted customers specified by the operator.

Then, in stage 916, the computer program determines the return on investment for the marketing material. In this stage, the computer program, utilizing the financial information from stage 912, the shipping cost from stage 914, and the production cost from stage 914, determines the return on investment. The return on investment represents percentage of profits to the costs.

Finally, in stage 918, the computer program outputs the return on investment for the marketing materials. The computer program can output the return on investment in the form of reports or graphs.

An exemplary return on the direct mail marketing software module for performing the process illustrated in FIG. 9 will now be explained with reference to FIGS. 3-10B. The software module can be configured to function on the system illustrated in FIG. 2. As in the previous aspect of the present invention, the operator executes the software module and introduction screen 300 is displayed as illustrated in FIG. 3. In this aspect, to execute a scenario, the operator toggles selectable component 330. In response, the computer module displays scenario screen 1000 illustrated in FIG. 10A.

Scenario screen 1000 allows the operator to select a pre-programmed volume by toggling one of the selectable components 1004, 1006, 1008, 1010, 1012, or 1014. Once the operator toggles one of the components, the software module displays the choice in field 1016. Then, the operator toggles selectable component 1018 to return to introduction screen 300.

In stage 900, the computer program receives data specifying either a standard or custom scenario. Next, in stage 902, if the computer has received information for a standard scenario, the computer program receives a number of customers targeted for a direct mail marketing campaign. The operator supplies the number of targeted customers to the computer program by selecting from a set of preprogrammed numbers of targeted customers. The number of targeted customers represents the number of pieces of marketing materials that will be produced and shipped.

Then, in stage 904, the computer program determines a production cost for producing the marketing material. The computer program is preprogrammed with scenario data for determining the production cost based on the number of targeted customers specified by the operator.

Also, in stage 904, the computer program determines the cost of the shipping service. The computer program is preprogrammed with scenario data for determining the shipping cost based on the number of targeted customers specified by the operator. The computer program is also preprogrammed with financial information, such as expected response rate of the target customers and an expected profit.

Then, in stage 906, the computer program determines the return on investment for the marketing material. In this stage, the computer program, utilizing the financial information determined in stage 904, the shipping cost from stage 904, and the production cost from stage 904, determines the return on investment. The return on investment represents percentage of profits to the costs.

The operator may also execute a custom scenario. As illustrated in FIG. 10A, at scenario screen 1000, the operator can view the custom scenario screen by toggling selectable component 1024. Once toggled, the software module displays scenario screen 1002. Scenario screen 1002 allows the operator to enter data on the pre-production and production costs of the marketing campaign. The fields and selectable components included in scenario screen 1002 correspond to fields and selectable components included in pre-production screen 400, production screen 500, and ROM$ screen 600. Scenario screen 1002 allows the operator to enter the data for pre-production screen 400, production screen 500, and ROM$ screen 600 in one screen, and this data will be used to populate the fields and selectable components of pre-production screen 400, production screen 500, and ROM$ screen 600. The function of the different fields and selectable components are explained above with reference to FIGS. 4, 5, and 6.

Once the operator has entered data on scenario screen 1002, the operator toggles selectable component 1020 to apply the custom scenario, and selectable component 1022 to return to introduction screen 300. The software module then functions in a similar manner as described above with reference to FIGS. 3-8. After the selected scenario, the operator enters the data for the introduction screen, and toggles selectable component 304 to proceed to pre-production screen 400.

Once in pre-production screen 400, instead of entering data, the operator toggles selectable component 438. Then, the operator either selects standard or custom scenario depending upon whether the operator selected standard or custom in scenario screens 1000 and 1002. Once the operator makes a selection, the software module populates the fields and selectable components with the data of the selected scenario. If the operator selected a standard scenario, the software module populates pre-production screen 400 with the preprogrammed data for the selected standard scenario. If the operator selected a custom scenario, the software module populates pre-production screen 400 with the data entered by the operator and preprogrammed data for any data not entered by the operator.

Then, the operator toggles selectable component 306 to proceed to production screen 500. Once in production screen 500, instead of entering data, the operator toggles selectable component 568. Then, the operator either selects standard or custom scenario depending upon whether the operator selected standard or custom in scenario screens 1000 and 1002. Once the operator makes a selection, the software module populates the fields and selectable components with the data of the selected scenario. If the operator selected a standard scenario, the software module populates production screen 500 with the preprogrammed data for the selected standard scenario. If the operator selected a custom scenario, the software module populates production screen 500 with the data entered by the operator and preprogrammed data for any data not entered by the operator.

Next, the operator toggles selectable component 308 to proceed to ROM$ screen 600. Once in ROM$ screen 600, instead of entering data, the operator toggles selectable component 672. Then, the operator either selects standard or custom scenario depending upon whether the operator selected standard or custom in scenario screens 1000 and 1002. Once the operator makes a selection, the software module populates the fields and selectable components with the data of the selected scenario. If the operator selected a standard scenario, the software module populates ROM$ screen 600 with the preprogrammed data for the selected standard scenario. If the operator selected a custom scenario, the software module populates ROM$ screen 600 with the data entered by the operator and preprogrammed data for any data not entered by the operator.

Finally, the operator can save and print any executive summary, save the data in campaign manager screen 700, and print a chart in chart screen 800. As in the operator entered data example, the operator can go back to introduction screen 300 and run a different scenario or operator entered data run.

In the processes described above, the operator can be an associate of the company that is performing the direct mail marketing campaign. In another aspect consistent with the present invention, the operator can be an associate of a shipping service. In this embodiment, the operator receives information about a prospective direct mailer seeking a direct mail marketing campaign. The operator then determines the return on investment of a direct mail marketing campaign based on the direct mailer's information. The operator then presents the return on investment to the prospective direct mailer. By this process, the shipping service can promote its services to a prospective direct mailer by illustrating the advantages of a direct mail marketing campaign to the prospective direct mailer.

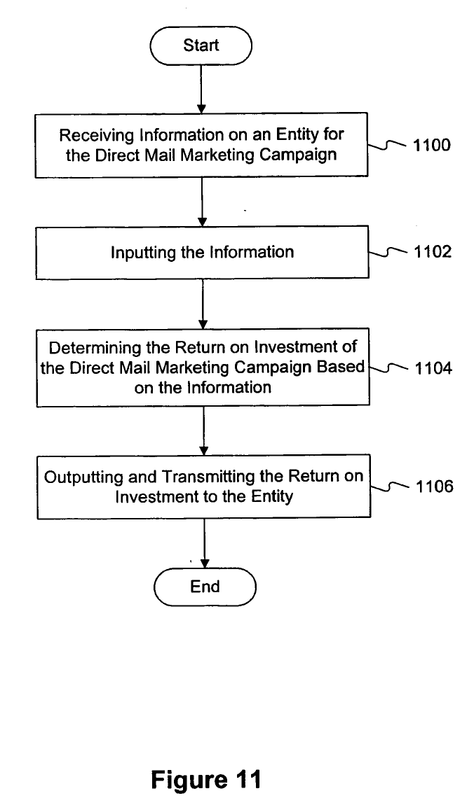

FIG. 11 illustrates the process for promoting a direct mail marketing campaign. The software module can be configured to function on the system illustrated in FIG. 2. In stage 1100, the operator receives information on an entity for the direct mail marketing campaign. This information can include the name of the entity, financial information of the entity, and parameters for a direct mail marketing campaign.

Then, in stage 1102, the operator inputs the entity's information in the computer program. Then, in stage 1104, the computer program determines the return on investment of the direct mail marketing campaign based on the information. The computer program can determine the return on investment using one of the processes described above in FIGS. 1 and 9.

Finally, in stage 1106, the computer program outputs the return on investment and the operator transmits the return on investment to the entity. The return on investment can be in the form of printable charts and graphs.

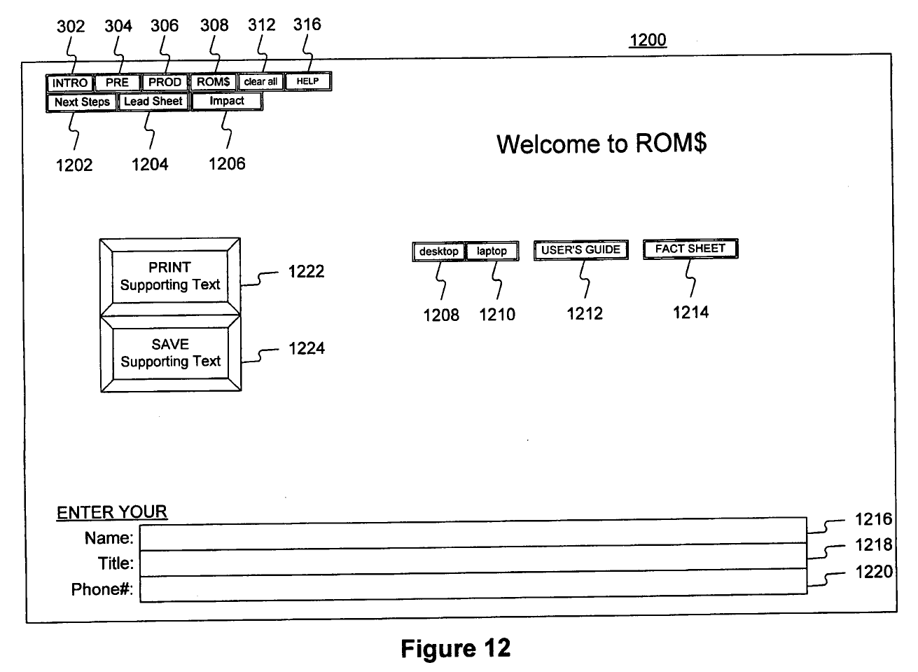

An exemplary return on the direct mail marketing software module for performing the process illustrated in FIG. 11 will now be explained with reference to FIGS. 12-14 and 3-10. The software module can be configured to function on the system illustrated in FIG. 2. FIGS. 12-14 and 3-8 are screen shots from the exemplary software module for performing the method illustrated in FIG. 11. When the operator executes the software module, welcome screen 1200 illustrated in FIG. 12 is displayed. Welcome screen 1200 allow the operator to his personal data, access information on the software module, and navigate to different screens.

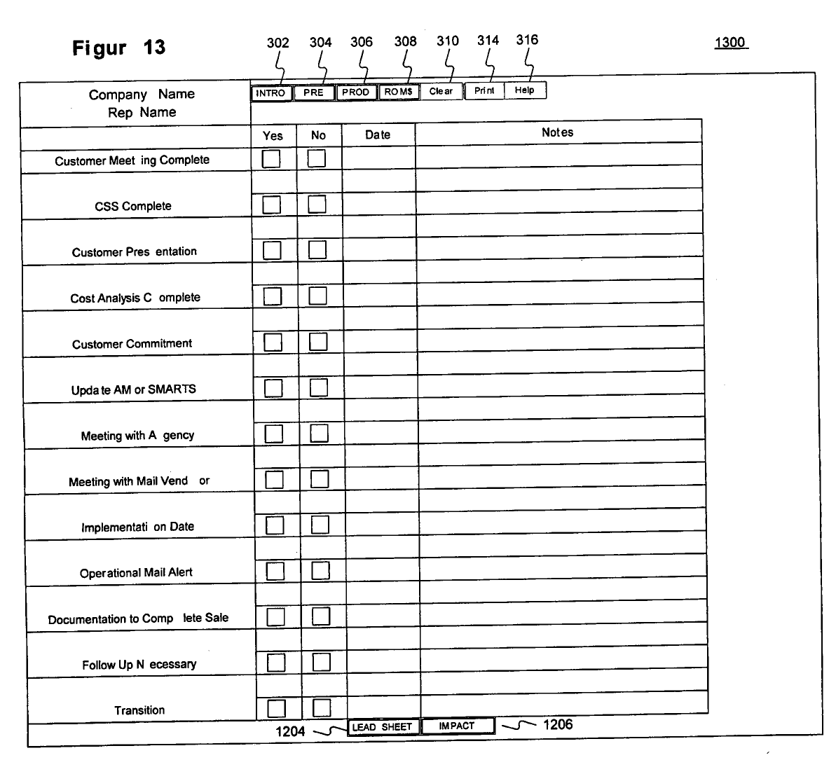

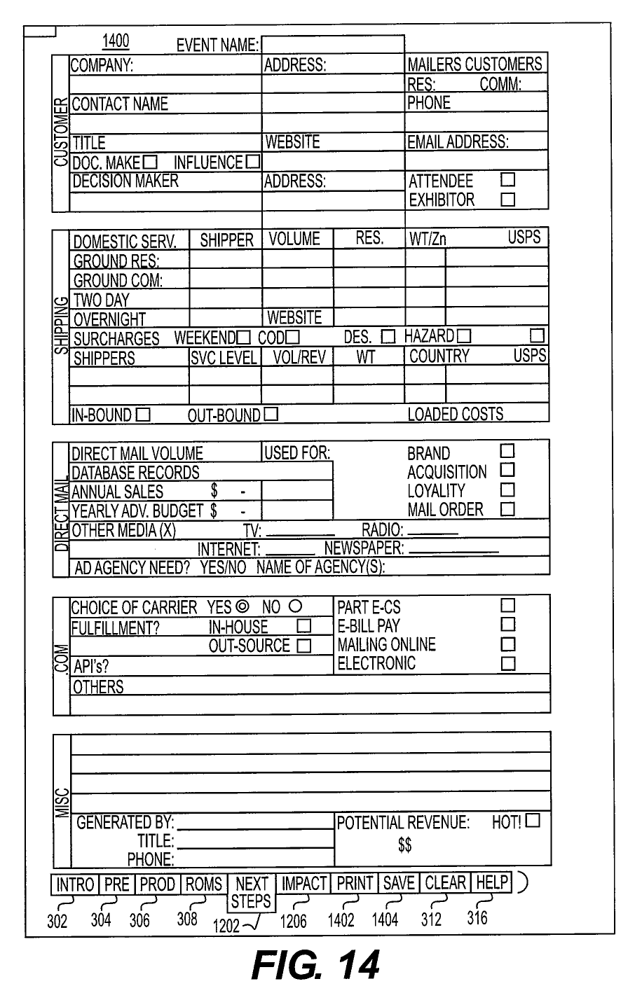

At the top of welcome screen 1200 are selectable components 302, 304, 306, 308, 1202, 1204, and 1206 which allow the operator to navigate to the different screens of the software module. Selectable component 302 allows the operator to navigate to introduction screen 300 (explained above with reference to FIG. 3). Selectable component 304 allows the operator to navigate to a pre-production screen 400 (explained above with reference to FIG. 4). Selectable component 306 allows the operator to navigate to a production screen 500 (explained above with reference to FIG. 5). Selectable component 308 allows the operator to navigate to a ROM$ screen 600 (explained above with reference to FIG. 6). Selectable component 1202 allows the operator to navigate to a next steps screen 1300 (explained below with reference to FIG. 13). Selectable component 1204 allows the operator to navigate to a trade show lead screen 1400 (explained below with reference to FIG. 14). Selectable component 1206 allows the operator to navigate to an impact screen. The impact screen displays information on the impact of a direct mail marketing campaign.

Also, welcome screen 1200 includes selectable components 312 and 316 that allow the operator to clear data from the screen and access help information.

The operator may also access information on the uses of the software module from welcome screen 1200. Selectable component 1212 allows the operator to access the user's guide for the software module. The user's guide explains the operation of the software module. Selectable component 1214 allows the operator to access a fact sheet on the software module. The fact sheet provides background information and the methodology of the software module. The operator can save and print the information from any information page from any screen by toggling selectable components 1222 and 1224.

Once the operator has viewed the supporting information and is ready to proceed, the operator begins by toggling selectable components 1208 or 1210. If the operator is executing the software module on a desktop, the operator toggles selectable component 1208. If the operator is executing the software module on a laptop, the operator toggles selectable component 1210. Then, the software module sets the software setting, such as screen size, either to laptop or desktop settings. Next, the operator enters his name, title, and phone number in fields 1216, 1218, and 1220, respectively.

After entering all the data, the operator proceeds to the other screens of the software module. If the operator is ready to evaluate the direct mail marketing campaign, the operator toggles selectable component 302 to proceed to introduction screen 300. After proceeding to introduction screen 300, the software module functions as described with reference to FIGS. 3-10B. The operator enters the prospective direct mailer's data information onto the various screens to determine a return on investment for the direct marketing. Then, the operator provides the return on investment data to the prospective direct mailer in order to illustrate the advantage of using a direct mail marketing campaign.

The operator can also execute the software module in the presence of a representative of the prospective direct mailer. This allows the operator to demonstrate how different parameters affect the return on investment of the direct mail marketing campaign. This also allows the operator to demonstrate how a direct mail marketing campaign can be custom tailed to the prospective direct mailer. These advantages will increase the likelihood that the prospective direct mailer will undertake a direct mail marketing campaign with the shipping service.

Before running the software module to determine the return on investment, the operator can toggle selectable components 1202 and 1204 in order to access next steps screen 1300 and lead sheet screen 1204. Next steps screen 1300 will be described with reference to FIG. 13. As with welcome screen 1200, next steps screen 1300 includes selectable components 302, 304, 306, 308, 310, 314, 316, 1204, and 1206 which allow the operator to navigate between the different screens, clear data from the screen, print the screen, and access help information.

Next steps screen 1300 includes a table of fields that allows the operator to keep track of the promotion process with a prospective direct mailer. For example, the operator can enter the prospective direct mailer name and representative. Then, the operator answers questions about the stages of the promotion process that have been completed and enters notes. This allows the operator to know precisely what stage the operator is at so as to prevent skipping stages or repeating stages for the prospective direct mailer.

Trade show lead screen 1400 will be described with reference to FIG. 14. As with welcome screen 1200, trade show screen 1400 includes selectable components 302, 304, 306, 308, 310, 314, 316, 1402, and 1404 which allow the operator to navigate between the different screens, clear data from the screen, print the screen, and access help information.

Trade show lead screen 1400 includes a table of fields that allow the operator to keep track of information for a prospective direct mailer and capture opportunity-specific information from the prospective direct mailer during a trade show event. The operator enters data which will be used to evaluate the potential of the lead for proper follow-up as a sales opportunity. The data entered into trade show lead screen 1400 can be used by the operator to prepare to meet with the potential direct mailer. Trade show lead screen 1400 can be completed electronically by the operator or printed and finished manually.

The above aspect of promoting a direct mail marketing campaign allows a shipping company to demonstrate the profitability and measurability of direct mail in tangible and real terms, using numbers from the prospective mailer's immediate environment. This has the added value of immediately and interactively involving the prospective direct mailer.

Further, the above aspect allows the shipping company to assist a prospective direct mailer in predicting the results of direct mail campaigns, giving the prospect abilities to understand the advantage of direct mail marketing. In addition, the shipping company will become an integral part of the prospect's marketing team, positioned to help them professionally as well as serve the shipping company.

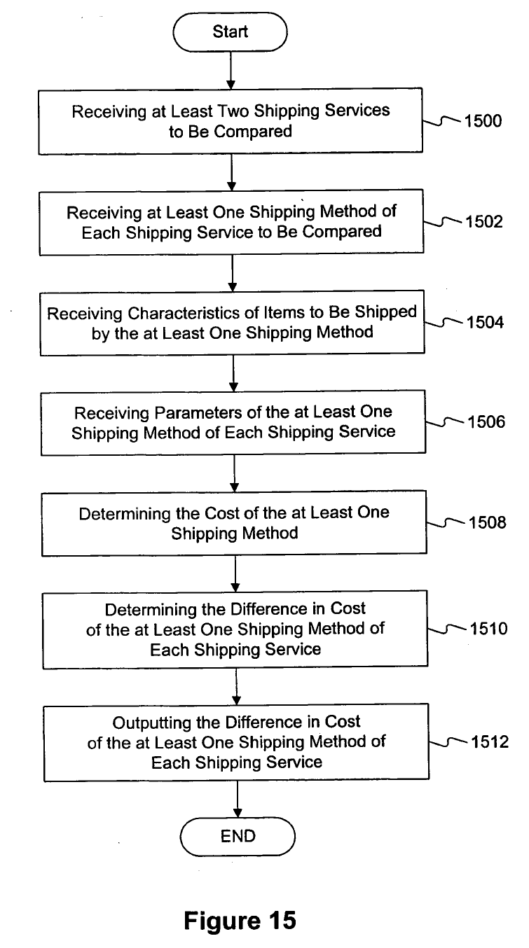

Another aspect consistent with the present invention concerns comparing the cost of shipping methods of various shipping companies. FIG. 15 illustrates the stages in the process for comparing the cost of shipping methods. This method may be performed by an operator and a computer program. The process can be performed on the computer system illustrate in FIG. 2. In stage 1500, the computer program receives data designating the shipping which an operator desires to compare. These shipping services may be supplied to the computer program by the operator or they may be preprogrammed in the computer program and selected by the operator. Examples of the shipping services would be USPS, UPS, or FedEx.

Next, in stage 1502, the computer program receives the shipping method of each shipping service to be compared. These shipping methods may be supplied to the computer program by the operator or they may be preprogrammed in the computer program and selected by the operator. The computer program may receive multiple shipping methods for each shipping service. An example of a shipping method would be priority mail offer by the USPS.

Then, in stage 1504, the computer program receives characteristics of the item to be shipped by the at least one shipping method. These characteristics may be supplied to the computer program by the operator or they may be preprogrammed in the computer program and selected by the operator. Examples of characteristics would be number of items, dimensions of the items, destination of the items, and weight of the items.

Next, in stage 1506, the computer program receives the parameters of the shipping methods of each shipping service. These parameters may be supplied to the computer program by the operator or they may be preprogrammed in the computer program and selected by the operator. Examples of characteristics would be primary charges, such as shipping price, secondary charges, such as address service charges, and surcharges, and discounts.

Then, in stage 1508, the computer program determines the cost of each shipping method. The computer program determines the cost for one item by summing all charges of the parameters of the shipping method and subtracting any discounts. Then, the cost for all items is determined by multiplying the cost of one item by the number of items.

Next, in stage 1510, the computer program determines the difference in cost of each shipping method. This difference in cost includes a total difference in cost and an annual difference in cost. These differences represent the savings of one shipping method over the other.

Finally, in stage 1512, the computer program outputs the difference in cost of the at least one shipping method determined in stage 1510.

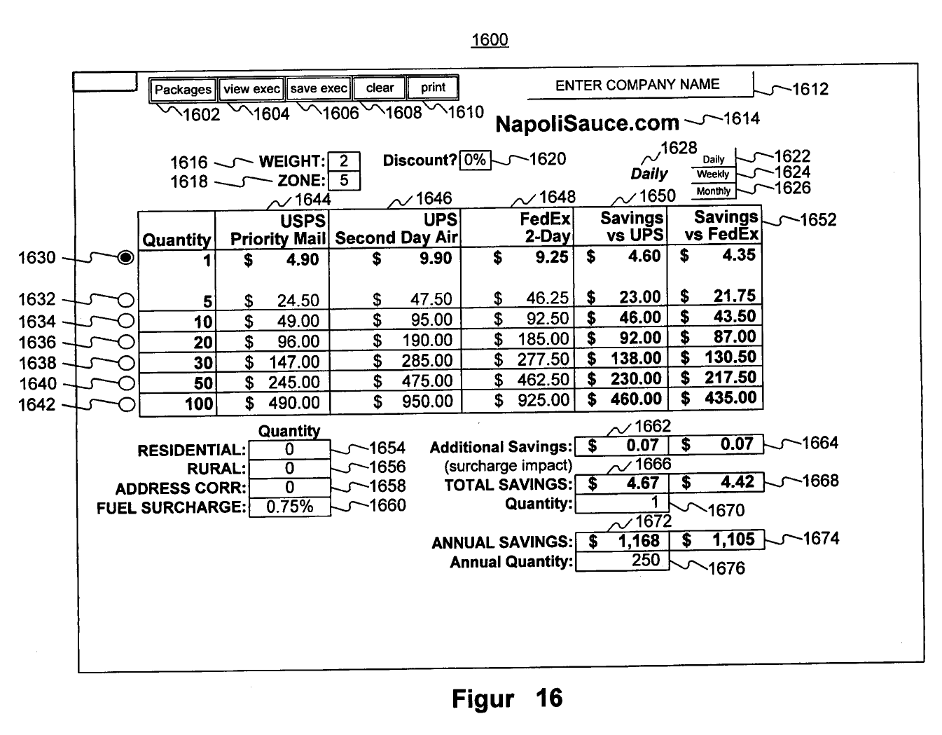

An exemplary software module for performing the method illustrated in FIG. 15 will now be explained with reference to FIG. 16. FIG. 16 is a mail screen 1600 from an exemplary software module for performing the method illustrated in FIG. 15. The software module can be run on a system illustrated in FIG. 2. The software module is designed to compare USPS Priority Mail against UPS Second Day Air and FedEx 2 Day Shipping. The software module functions by receiving the various parameters in the fields shown in FIG. 16.

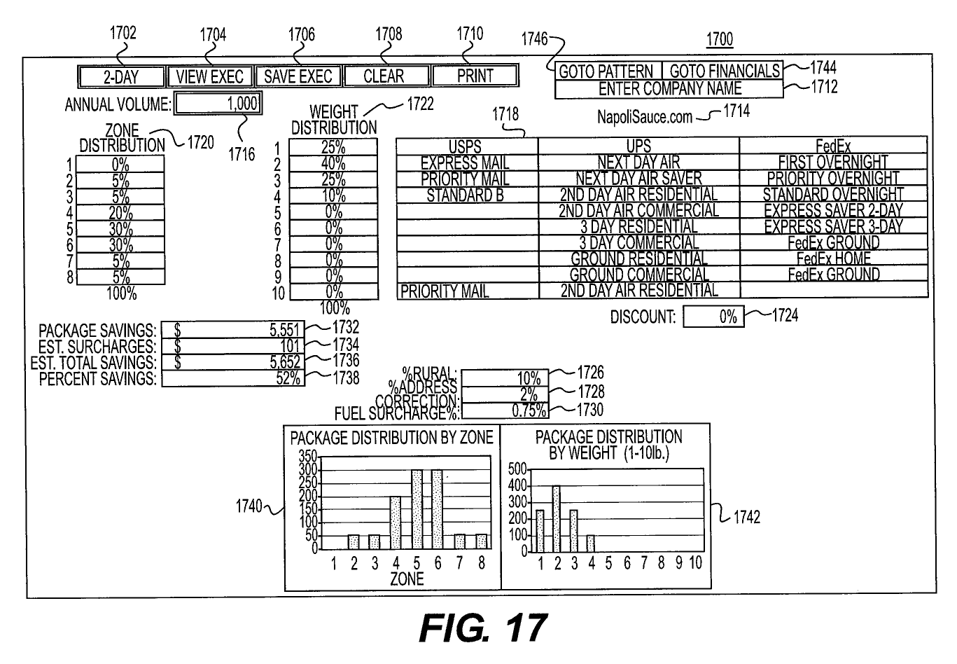

At the top of the mail screen 1600 is selectable component 1602 which allows the operator to navigate to a different screen of the software module. Selectable component 1602 allows the operator to navigate to package screen 1700 (explained below with reference to FIG. 17).

Also, mail screen 1600 includes selectable components 1604, 1606, 1608, and 1610 that allow the operator to view an executive summary of the data entered on the page, save the executive summary, clear data from the screen, and print information.

First, the operator identifies the company name by toggling selectable component 1612 and then entering the company name. The company name is displayed in field 1614. In this case, the fictional company name is NapoliSauce.com.

Next, the operator enters the weight code and zone code in fields 1616 and 1618, respectively. Next, the operator enters any discount available for the type of shipping method under comparison in field 1620. For example, a delivery system operator may offer a customer a discount depending on the shipment size and type of payment method.

Then, the operator selects the time period to be evaluated by toggling one of the selectable components 1622, 1624, and 1626. The time period selected is displayed in field 1628. The time period represents the amount of time the volume selected in the next stage will be shipped. In this example, a time period of daily has been selected.

Next, the operator selects the volume of items to be shipped in the time period by toggling one of the selectable components 1630, 1632, 1634, 1636, 1638, 1640, and 1642. The operator may select between a volume of 1, 5, 10, 20, 30, 50, and 100 items to be shipped in the time period. In this example, a volume of 1 has been selected. Also, in this example, the cost of shipping the volume selected for USPS priority mail, UPS second day air, and FedEX 2-Day are pre-computed and supplied to the software module. These values are displayed in columns 1644, 1646, and 1648, respectively, for each volume amount. The software module compares the cost of USPS priority mail with UPS second day air and FedEx 2-day and displays the difference in columns 1650 and 1652. The difference represents the savings for one delivery system operator rather than others. The savings are displayed in columns 1650 and 1652 for each volume.

Now, the operator enters any additional charges related to the shipment methods of various delivery system operators. In this example, the extra charges may be entered in fields 1654, 1656, 1658, and 1660 for residential shipping, rural shipping, address correction, and fuel surcharge, respectively. In this example, a fuel surcharge of 0.75% is entered.

Finally, the software module calculates the savings of shipping with one delivery system operator rather than others. First, the software module calculates additional savings for using USPS priority mail. The additional savings are calculated by applying the extra charges entered in fields 1654, 1656, 1658, and 1660 to the cost of UPS and FedEx shipment services. In this example, a fuel surcharge of 0.75% is multiplied by the cost of the UPS second day air, $9.90, and the volume of items, 1. The software module determines an additional savings of $0.07 for UPS second day air. The software module displays the additional savings in field 1662. The software module then performs the same calculation for FedEx 2-Day and displays the additional charge in field 1664.

Next, the software module calculates the total savings for the volume selected and displays the results in fields 1666 and 1668. The software module calculates the total savings by adding the savings from columns 1650 and 1652 for the selected volume with the additional savings displayed in fields 1662 and 1664. In this example, for UPS second day air, a savings of $4.60 is added with the additional savings to find a total savings of $4.67 which is displayed in field 1666. The software module performs the same calculation for FedEx 2-Day and the total savings is displayed in field 1668. The software module also displays the volume selected by the operator in field 1670.

Next, the software module calculates the annual savings and displays the results in fields 1672 and 1674. The annual savings is determined by multiplying the total savings by the time period displayed in field 1628. In this example, since the operator selected daily, the software module multiplies the total savings by the number of business days in a year. For the UPS second day air, the software module multiplies the total savings, $4.67, by the number of business days in a year, 250 (260 business days in a year minus 10 holidays). The software module calculates an annual savings of $1,168 which is displayed in field 1672. The software module performs the same calculation for FedEx 2-Day and determines an annual savings of $1,105 which is displayed in field 1674. The software module also displays the annual volume in field 1676. If daily or monthly was selected, the software module would multiply the total savings by the number of weeks, 52, and months, 12, respectively.

Once the software module is finished with the calculations, the operator may save all the settings or print out the results. Also, the operator may change the various settings to determine the savings for different parameters. For example, the operator may change the volume to determine the savings if more items are shipped over the time period.

Next, the operator can proceed to package screen 1700 by toggling selectable component 1602. Package screen 1700 will now be described with reference to FIG. 17. Package screen 1700 can also be run simultaneously with mail screen 1600.

At the top of the package screen 1700 is selectable component 1702 which allows the operator to navigate to a different screen of the software module. Selectable component 1702 allows the operator to navigate to mail screen 1600 (explained above with reference to FIG. 16).

Also, package screen 1700 includes selectable components 1704, 1706, 1708, and 1710 that allow the operator to view an executive summary of the data entered on the page, save the executive summary, clear data from the screen, and print information.

First, the operator identifies the company name by toggling selectable component 1712 and then entering the company name. The company name is displayed in field 1714. In this example, the fictional company name is NapoliSauce.com.

Then, the operator selects two shipping methods to be compared from table 1718. The operator can select from USPS express mail, USPS priority mail, USPS standard B, UPS next day air, UPS next day air saver, UPS 2^{nd} day air residential, UPS 2^{nd} day air commercial, UPS 3 day residential, UPS 3 day commercial, UPS ground residential, UPS ground commercial, FedEx first overnight, FedEx priority overnight, FedEx standard overnight, FedEx express saver 2-day, FedEx express saver 3-day, FedEx ground, and FedEx home. In this example, the operator selects USPS priority mail and UPS 2^{nd} day air residential.

Next, the operator specifies the zone distribution and the weight distribution in tables 1720 and 1722, respectively. Zone distribution table 1720 allows the operator to specify the volume designated for each of the eight zones. Weight distribution table 1722 allows the operator to specify the volume in weight increments of 1 to 10. The operator specifies the distribution by a percentage of the volume entered in field 1716. The software module will multiply the percentage by the volume to determine the specific weights and zones. The software module also displays the zone and weight distribution graphically in graphs 1740 and 1742. In this example, the operator enters a zone distribution of 5% in zone 2, 5% in zone 3, 20% in zone 4, 30% in zone 5, 30% in zone 6, 5% in zone 7, and 5% in zone 8.

Next, the operator enters any discount available for the type of shipping method under comparison in field 1724. For example, a delivery system operator may offer a customer a discount depending on the shipment size and type of payment method.

Now, the operator enters any additional charges related to shipment methods of UPS and FedEx. The extra charges may be entered in fields 1726, 1728, and 1730 for rural shipping, address correction, and fuel surcharge, respectively. In this example, a rural shipping surcharge of 10%, an address correction surcharge of 2%, and a fuel surcharge of 0.75% are entered.

Finally, the software module calculates the savings of shipping with the different shipping services. First, the software module calculates package savings and displays the result in field 1732. The software module calculates the savings by determining the total shipping cost for each service and then finding the difference in cost between the services. The difference in cost is the package savings. The software module is preprogrammed with the rates tables for each of the shipping methods listed in table 1718. Thus, to calculate the total cost of shipping for each shipping service, the software module accesses the preprogrammed table based on the zone and weight distribution to find the rate and then subtract any discounts. For example, if the operator specified a volume of 100, a zone 1 distribution of 100%, and a 100% weight distribution of 1 lb, the software module would access the rate table for zone 1 and determine the shipping rate for 100 packages (100% of 100) weighing 1 lb (100% of 1 lb). In this example, the software module determines a package savings of $5,551.

Next, the software module determines the estimated surcharges by summing the surcharges entered in fields 1726, 1728, and 1730. Then, the software module calculates the estimated total savings by adding the package savings and estimated surcharges and displaying the results in field 1736. Finally, the software module calculates a percentage savings by dividing the estimated savings by the total shipping charge and displays the result in field 1738. In this example, the estimated surcharges, estimated total savings, and the percentage savings are $101, $5,652, and 52%, respectively.

Once the savings are calculated, the operator can print or save the results by toggling selectable components 1710 and 1706. Additionally, the operator can toggle selectable component 1746 to access larger versions of graphs 1740 and 1742. Also, the operator can toggle selectable component 1744 to access the graphs and tables of the rate calculations used by software module to determine the savings.

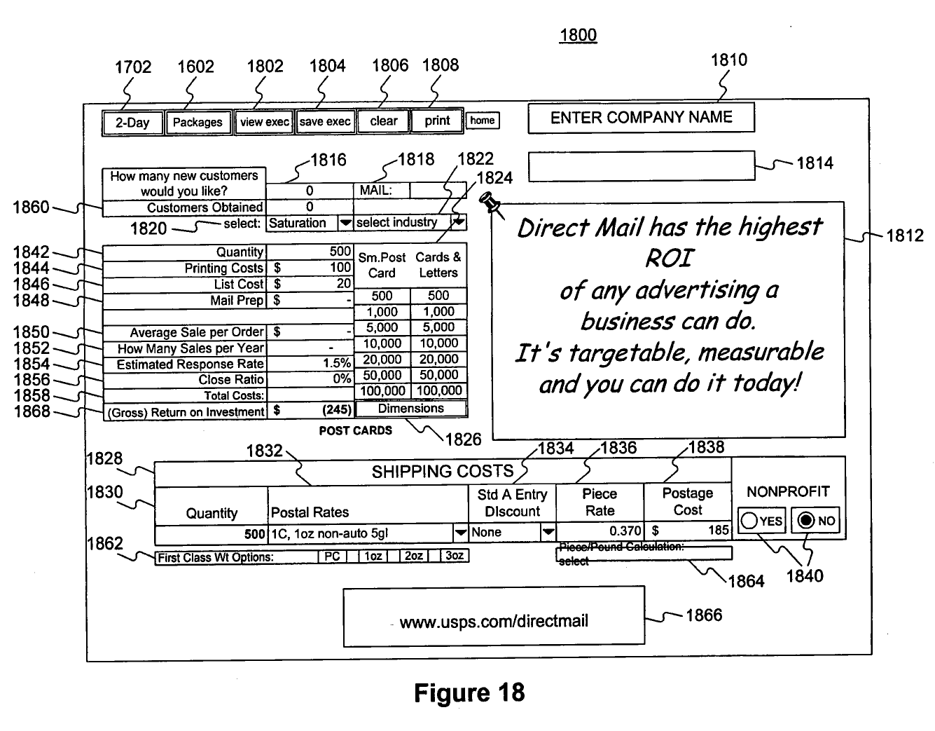

Next, the operator can proceed to direct mail screen 1800. Direct mail screen 1800 will now be described with reference to FIG. 18. Direct mail screen 1800 can be reached by toggling selectable components (not shown) on mail screen 1600 and package screen 1700. Alternatively, direct mail screen 1800 can be run simultaneously with package screen 1700 and mail screen 1600.

At the top of the direct mail screen 1800 are selectable components 1702 and 1602 which allow the operator to navigate to different screens of the software module. Selectable component 1702 allows the operator to navigate to mail screen 1600 (explained above with reference to FIG. 16). Selectable component 1602 allows the operator to navigate to package screen 1700 (explained above with reference to FIG. 17).

Also, direct mail screen 1800 includes selectable components 1802, 1804, 1806, and 1808 that allow the operator to view an executive summary of the data entered on the page, save the executive summary, clear data from the screen, and print information.

First, the operator identifies the company name by toggling selectable component 1810 and then entering the company name. The company name is displayed in field 1814. Direct mail screen 1800 also includes field 1812 that displays the advantages of a direct mail campaign.

Next, the operator enters the number of desired customers in field 1816 and the type of mail in field 1818. Then, the operator specifies the mailing volume by toggling selectable component 1820 and selecting the desired volume from a pre-programmed list. In this example, the operator selected saturation.

Then, the operator specifies the type of industry by toggling selectable component 1822 and then selecting the industry type from a pre-programmed list.

Next, the operator specifies the type and amounts of direct mail to ship to prospective customers. The operator specifies the type of direct mail by selecting one of the pre-programmed volume and types displayed in table 1824. In this example, table 1824 consists of a column for small post cards and a column for card and letters. Table 1824 also consists of rows for volume amounts of 500, 1,000, 5,000, 10,000, 20,000, 50,000, and 100,000. The amount selected by the operator is displayed in field 1842. The operator can also specify the dimensions of the direct mail by toggling selectable component 1826 and entering the dimensions.

Now, the operator specifies the shipping costs for the select direct mail in table 1828. Table 1828 includes columns 1830, 1832, 1834, 1836, and 1838 for entering values for quantity, postal rates, discounts, piece rates, and postage costs.

Column 1830 displays the quantity (number of pieces) that will be shipped in the direct mail marketing campaign. The software module automatically populates column 1830 with the amount to be shipped specified by the operator in table 1824. In this example, the software module populates column 1830 with a quantity of 500.

Next, the operator specifies the postal rate of the direct mail in column 1832. Column 1832 is a selectable component that allows the operator to select from various standard shipping rates. For example, the selectable components in column 1832 may include standard USPS shipping rates for each type of marketing mail piece, such as letter auto 3-digit and letter auto mixed and 1 C, 1 oz non-auto Sgi. The different shipping rates are obtained from the shipping service and are stored in the software module. In this example, the operator selects letter auto 1 C, 1 oz non-auto Sgi.

Then, the operator specifies any discounts available for the type of postal rate selected in column 1834. Column 1834 is a selectable component that allows the operator to select from various standard shipping rate discounts. For example, if the direct mail marketing material is being shipped in a certain geographic area, certain discounts may apply for certain postal rates. These discounts are available from the shipping service and stored in the software module. In this example, the operator selects no discount.

Mail screen 1800 also includes selectable component 1862. If a First-Class Mail rate is selected, different weight options can be chosen with selectable component 1862. Changing the weight class will effect the shipping rate.

Mail screen 1800 also includes selectable component 1864. If a catalog or sample weighs more than 3.3 ounces, selectable component 1864 will allow the operator to select the appropriate rate category and weight in ounces.

Once the operator has selected the shipping rate and any discount, the software module calculates the shipping rate per piece. The software module determines the piece rate by determining the shipping rate selected by the operator and displays this amount in column 1836. In this example, the software module accesses the stored shipping rates and displays a rate of $0.370 in column 1836.

Then, the software module determines the total shipping cost by multiplying the shipping rate per piece displayed in column 1836 by the quantity of pieces displayed in column 1830 and subtracting any discounts displayed in column 1834. The software module displays the results in column 1838. In this example, the shipping costs $185.

Additionally, the operator defines whether the company using the software module is non-profit by toggling “YES” or “NO” in selectable component 1840. If the operator toggles “YES,” the software module will activate the Non-Profit rate tables for all of the calculations. If the operator toggles “NO,” the software module will activate the Regular Standard Shipping rates for all the calculations.

Next, the operator enters the costs associated with producing the direct mail pieces. These include printing cost (field 1844), list cost (field 1846), and mail preparation cost (field 1848). Production costs are discussed in more detail above with reference to other aspects of the present invention.

Then, the operator enters the expected results of the direct mail. These include average sale per order (field 1850), number of sales per year (field 1852), estimated response rate (field 1854), and close ratio (field 1856). The average sale per order is the average amount of money made on each customer order. The estimated response rate is the rate of response that is expected for the marketing materials, based on factors including offer, list targeting, and creativity. In this example, the actual or assumed response rate is 1.5%. The close ratio is the percentage of responding customers that actually make an order.

From the estimated response rate, the software module calculates the customers obtained by multiplying the response rate, the quantity of direct mail pieces, and the close ratio. The software module displays the result in field 1860.

Now, the software module calculates the total cost by adding the production cost from fields 1844, 1846, and 1848 and the shipping cost from column 1838. The software module displays the total cost in field 1858.

Finally, the software module calculates the gross return on investment by subtracting the total costs from the gross profits. The gross profits is determined by multiplying the number of customers obtained, the average sale, and the number of sales per year. The software module displays the gross return on investment in field 1868. In this example, an average sale per order was not entered thus, a negative gross return on investment was determined.

Once the return on investment is calculated, the operator can print or save the results by toggling selectable components 1808 and 1804. Additionally, the operator can toggle selectable component 1866 to access more information on direct mail.

As described above, the operator enters the various parameters for the direct mail. Alternatively, when the operator toggles the selectable components 1820 and 1822, the software module can automatically populate the various fields with preprogrammed data. This allows the operator to test or demonstrate the software module without knowing the exact parameters for the direct mail.

The shipping service comparison process described above allows a company to determine the best method possible for shipping an item. Further, the shipping service comparison allows a shipping service to promote their shipping method by demonstrating the savings achieved over competitors. As such, the shipping service comparison process can be used in combination with the direct mail marketing process and direct mail promotion process described above.

Likewise, the software modules for performing the shipping service comparison, evaluation process, and direct mail promotion process were describe separately. Nonetheless, one skilled in the art would recognize that the software modules could be integrated as one software module

The above processes and software modules were described with reference to shipping marketing material via a shipping service. Nonetheless, the processes and software modules are versatile enough to use other parameters of costs depending upon the type of the marketing campaign. Thus, the method could be employed in evaluating the effectiveness of other types of marketing efforts used in reaching the customers. Such other methods of reaching the customers are advertising in media, like radio, TV, newspapers, internet websites, etc.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1-48. (canceled)

49. A method for comparing shipping services, comprising:
receiving at least two shipping services to be compared;
receiving at least one shipping method of each shipping service to be compared;
receiving characteristics of items to be shipped by the at least one shipping method;
receiving parameters of the at least one shipping method of each shipping service;
determining the cost of the at least one shipping method;
determining the difference in cost of the at least one shipping method of each shipping service; and
outputting the difference in cost of the at least one shipping method of each shipping service.

50. The method according to claim 49, wherein selecting the characteristics of items to be shipped comprises:
receiving a quantity of items;
receiving a weight class of the items; and
receiving a geographic location of the items.

51. The method according to claim 50, wherein
receiving the weight class comprises receiving multiple weight classes and receiving a distribution of the quantity of items over the multiple weight class; and
receiving the geographic location of the items comprises receiving multiple geographic locations and receiving a distribution of the quantity of items over the multiple geographic location.

52. The method according to claim 49, wherein determining the parameters of each shipping method, comprises:
receiving primary charges associated with the at least one shipping method;
receiving secondary charges associated with the at least one shipping method; and
receiving discounts associated with the at least one shipping method.

53. The method according to claim 52, wherein the primary charges associated with the at least one shipping method comprise:
a shipping fee.

54. The method according to claim 52, wherein the secondary charges associated with the at least one shipping method comprise:
a residential surcharge, a rural surcharge, an address correction fee, and a fuel surcharge.

55. The method according to claim 49, wherein outputting the difference in cost comprises outputting a difference in total cost and annual costs.

56. A system for comparing shipping services, comprising:
means for receiving at least two shipping services to be compared;
means for receiving at least one shipping method of each shipping service to be compared;
means for receiving characteristics of items to be shipped by the at least one shipping method;
means for receiving parameters of the at least one shipping method of each shipping service;
means for determining the cost of the at least one shipping method;
means for determining the difference in cost of the at least one shipping method of each shipping service; and
means for outputting the difference in cost of the at least one shipping method of each shipping service.

57. The system according to claim 56, wherein the means for selecting the characteristics of items to be shipped comprises:
means for receiving a quantity of items;
means for receiving a weight class of the items; and
means for receiving a geographic location of the items.

58. The system according to claim 57, wherein
the means for receiving the weight class comprises means for receiving multiple weight classes and means for receiving a distribution of the quantity of items over the multiple weight class; and
the means for receiving the geographic location of the items comprises means for receiving multiple geographic locations and means for receiving a distribution of the quantity of items over the multiple geographic location.

59. The system according to claim 56, wherein the means for determining the parameters of each shipping method, comprises:
means for receiving primary charges associated with the at least one shipping method;
means for receiving secondary charges associated with the at least one shipping method; and
means for receiving discounts associated with the at least one shipping method.

60. The system according to claim 59, wherein the primary charges associated with the at least one shipping method comprise:
a shipping fee.

61. The system according to claim 59, wherein the secondary charges associated with the at least one shipping method comprise:
a residential surcharge, a rural surcharge, an address correction fee, and a fuel surcharge.

62. The system according to claim 56, wherein outputting the difference in cost comprises outputting a difference in total costs and annual costs.

63. A computer readable medium including instructions for causing a computer system to execute a method for comparing shipping services, the method comprising:
receiving at least two shipping services to be compared;
receiving at least one shipping method of each shipping service to be compared;
receiving characteristics of items to be shipped by the at least one shipping method;
receiving parameters of the at least one shipping method of each shipping service;
determining the cost of the at least one shipping method;
determining the difference in cost of the at least one shipping method of each shipping service; and
outputting the difference in cost of the at least one shipping method of each shipping service.

64. The computer readable medium according to claim 63, wherein selecting the characteristics of items to be shipped comprises:
receiving a quantity of items;
receiving a weight class of the items; and
receiving a geographic location of the items.

65. The computer readable medium according to claim 64, wherein
receiving the weight class comprises receiving multiple weight classes and receiving a distribution of the quantity of items over the multiple weight class; and
receiving the geographic location of the items comprises receiving multiple geographic locations and receiving a distribution of the quantity of items over the multiple geographic location.

66. The computer readable medium according to claim 63, wherein determining the parameters of each shipping method, comprises:
receiving primary charges associated with the at least one shipping method;
receiving secondary charges associated with the at least one shipping method; and
receiving discounts associated with the at least one shipping method.

67. The computer readable medium according to claim 66, wherein the primary charges associated with the at least one shipping method comprise:
a shipping fee.

68. The computer readable medium according to claim 66, wherein the secondary charges associated with the at least one shipping method comprise:
a residential surcharge, a rural surcharge, an address correction fee, and a fuel surcharge.

69. The computer readable medium according to claim 63, wherein outputting the difference in cost comprises outputting a difference in total cost and annual costs.

70-86. (canceled)

87. A system for comparing shipping services, comprising:
a component receiving at least two shipping services to be compared;
a component receiving at least one shipping method of each shipping service to be compared;
a component receiving characteristics of items to be shipped by the at least one shipping method;
a component receiving parameters of the at least one shipping method of each shipping service;
a component determining the cost of the at least one shipping method;
a component determining the difference in cost of the at least one shipping method of each shipping service; and
a component outputting the difference in cost of the at least one shipping method of each shipping service.

88-90. (canceled)
